(19) United States
(12) Patent Application Publication
(10) Pub. No.: US 2006/0209012 A1
(43) Pub. Date: Sep. 21, 2006

(54) Devices having MEMS displays

(75) Inventor: Nesbitt W. Hagood IV, Wellesley, MA (US)

Correspondence Address: FISH & NEAVE IP GROUP;ROPES & GRAY LLP, ONE INTERNATIONAL PLACE, BOSTON, MA, 02110-2624, US

(73) Assignee: Pixtronix, Incorporated, Andover, MA (US)

(21) Appl. No.: 11/361,294

(22) Filed: Feb. 23, 2006

Related U.S. Application Data
(60) Provisional application No. 60/676,053, filed on Apr. 29, 2005.
(60) Provisional application No. 60/655,827, filed on Feb. 23, 2005.

(51) Int. Cl. G09G 3/34

(52) U.S. Cl. 345/109

(57) ABSTRACT

Improved portable hand held devices having bright, high resolution MEMS display panels with shutters and optionally optical cavities having both front and rear reflective surfaces. Light-transmissive regions are formed in the front reflective surface for spatially modulating light.

### CROSS-REFERENCE TO RELATED APPLICATIONS

This application incorporates by reference in entirety, and claims priority to and benefit of, U.S. Provisional Patent Application Ser. No. 60/676,053, entitled “MEMS Based Optical Display” and filed on Apr. 29, 2005; and U.S. Provisional Patent Application No. 60/655,827, entitled MEMS Based Optical Display Modules” and filed on Feb. 23, 2005.

### BACKGROUND OF THE INVENTION

Today, more and more devices are being built that provide powerful computing and communication platforms with a handheld form factor. The accelerating introduction of these useful devices has been driven largely by the rapid development of new microprocessor chips that each year include more computational power in a smaller package.

This increased computational power allows today's handheld devices to provide a greater variety of functions and applications for communication, data processing, entertainment and other uses. As the handheld devices are required to do more and more, the user interface becomes a more critical part of the device. The more functionality being provided by these devices, the more the user interfaces need to be cleverly designed to provide users with ways to select options, enter input and to provide output. To this end, engineers have developed new user interface devices, such as thumb wheels, reduced size keyboards, touch sensitive input wheels, touch screens and other such devices.

Although these user interface devices and tools can be quite helpful, the ever increasing processing power and capabilities of today's micro processors makes the display a central part of the user interface. Today's handheld devices use almost exclusively LCD panels. The LCD panels, although very reliable, become very costly and power hungry when designed for the high end applications, like color video. This causes device manufacturers to use costly, power hungry panel designs for devices that only need the functionality for some applications. This leads to wasted power and added cost. As such, the constant challenge for design engineers is to come up with portable handheld, or “pocketable,” devices that are more easy to use and that allow users to navigate through the myriad of choices that are now provided.

Accordingly, there is a need in the art for improved portable handheld devices that more completely and effectively allow users to access and control the functions provided by the device.

### SUMMARY OF THE INVENTION

The systems and methods described herein provide, among other things, portable handheld devices that include housings with a form factor that facilitates being held in one or both hands during operation. The systems include entertainment systems, media players, television sets, game playing systems, smart phones, cell phones, digital cameras, view finders, e-books, and other devices and include a user interface that has a display capable of conveying information and optionally to collect input from the user. The display includes a bright, low power display panel that is seated within a housing and that has a light modulating layer with a plurality of transversely moveable shutters arranged to modulate light by transversely moving shutters through a path of a propagating beam or ray of light, thereby setting the respective pixel into an on or an off condition. Additionally, the portable handheld device comprises a control matrix that is coupled to the display panel and provides control over respective ones of the transversely moveable shutters thereby allowing movement of the transversely moveable shutters to modulate light. A power source is disposed within the housing and may be coupled to a light source and to the control matrix.

Optionally, the portable handheld device may include a display controller that is coupled to the control matrix for controlling the moveable shutters to display an image. The display controller may include a color image generator that is capable of determining a sequence of on and off conditions for each respective moveable shutter and driving each shutter through the predetermined sequence to display a color image.

More particularly, the systems and methods described herein include portable handheld devices, having a housing, a display panel seated within the housing and having a light modulating layer with a plurality of transversely moveable shutters capable of modulating light by transversely moving the respective shutter through a path of a propagating ray of light to set a respective pixel in an on condition or an off condition. A
control matrix couples to the display panel to provide control over respective ones of the transversely moveable shutters for moving said transversely moveable shutters to modulate light. The control matrix may be for a passive or active matrix display and may have a plurality of control circuits each being associated with a respective moveable shutter. A power source disposed within the housing and coupled to the light source and the controller. The portable handheld device can be among other things, game consoles, cell phones, audio players, video players, watches, e-books, digital cameras, televisions, GNSS receivers, and laptop computers.

Optionally, the portable handheld device has a display controller coupled to the control matrix for controlling the moveable shutter elements to display an image. The display controller may include a color image generator, typically a programmable logic device, that is capable of determining a sequence of on and off conditions for the moveable shutters and for driving respective moveable shutters through the determined sequence to display a color image.

Optionally and alternatively, the portable handheld device may have at least one color filter disposed within the display panel, and the display controller may include a sync controller coupled to the display panel and generating a sync pulse to move a group of moveable shutters to a selected state at predetermined intervals. An image memory may be used that has storage for an image signal and being coupled to the controller, and the memory may be a removable memory storage device.

The display panel may have a transparent substrate joined to a lower surface of the light modulating layer, and a light source disposed beneath the transparent substrate. A plurality of light sources may be used, each capable of generating a selected color, and the display controller or a separate light controller can be provided to sequentially activate the plurality of light sources to display a color image. 1 The display controller may also provide or have a color bit controller for controlling the number of color bits employed for generating an image.

The devices may have a user interface device coupled to the housing and capable of generating input signals responsive to user commands, and a touch sensitive screen disposed over an upper surface of the display panel and capable of generating signals representative of a location on the display panel being pressed by a user. The cover plate may have a thickness selected to limit an inwardly directed deformation in response to an exterior pressure, and supports disposed between the light modulating substrate and a cover plate may butt against and support the cover plate.

A power controller can couple to the power source and have a plurality of operating modes for selectively regulating power drawn from the power source.

A timer can direct the power controller to change the amplitude at which the light source is driven after a selected period of time or the timing at which the source switches. The power controller can control timing at which at least one of the light sources switches to generate colors that draw less power from the power source, and can control a light source to generate monochromatic light with a non-switched light source.

A level detector can couple to the power controller for measuring a light external to the housing and for selectively regulating power drawn from the power source at least in part based on the measure.

A moveable contact formed on the light modulating layer and coupled to the control matrix and arranged for moving toward a respective moveable shutter can reduce a voltage applied to move the shutter.

Methods for using and manufacturing such devices are also described.

### BRIEF DESCRIPTION OF THE FIGURES

The system and methods may be better understood from the following illustrative description with reference to the following drawings in which:

FIG. 1 depicts one embodiment of a portable handheld device according to the invention;

FIG. 2 depicts in more detail an example of an image of the type that may be displayed on the portable hand held device depicted in FIG. 1;

FIG. 3 depicts a functional block diagram of the functional elements of the portable held hand device depicted in FIG. 1;

FIG. 4 depicts in more detail the functional elements of the display controller depicted in FIG. 3;

FIG. 5A is a conceptual diagram of a control matrix suitable for controlling moveable shutters in a display panel;

FIG. 5B is an isometric view of an array of pixels incorporating the control matrix of FIG. 5A;

FIGS. 6A, 6B and 6C depict in more detail alternative embodiments of a display panel according to the invention wherein FIG. 6B includes three color filters;

FIG. 7 depicts an alternate embodiment of a display panel having a back light;

FIG. 8 depicts an alternate embodiment of a display panel;

FIG. 9 depicts an alternate embodiment of a portable hand held device according to the invention;

FIG. 10 depicts a smart phone embodiment of a portable device according to the invention;

FIGS. 11A and 11B depict an e-book embodiment of a portable device according to the invention;

FIG. 12A depicts a watch embodiment of the invention having a segmented display depicted in more detail in FIG. 12B;

FIG. 13 depicts a media player embodiment of the portable handheld device;

FIG. 14 depicts a GNSS receiver portable handheld device;

FIG. 15 depicts a laptop according to the invention;

FIGS. 16 and 17 depict alternative embodiments of a MEMS display panel; and

FIG. 18 depicts an embodiment of a reflective MEMS display panel suitable for use with the devices described herein.

### DESCRIPTION OF CERTAIN ILLUSTRATIVE EMBODIMENTS

To provide an overall understanding of the invention certain illustrative embodiments will now be described, including portable handheld devices and methods for making the same. However, it will be understood by one of ordinary skill in the art that the systems and methods described herein may be adapted and modified as is appropriate for the application being addressed and that the systems and methods described herein may be employed in other suitable applications, and that such other additions and modifications will not depart from the scope hereof.

More particularly, the systems and methods described herein include, among other things portable handheld devices and methods for making portable handheld devices that include low power and brightly lit display panels with sufficient resolution to provide a visual user interface with visually distinct images capable of being viewed under multiple ambient lighting conditions. More particularly, the systems and methods described herein include, in certain embodiments, portable handheld devices that include displays comprising a MEMS display panel that has a light modulating layer. The light modulating layer includes pixel elements organized to provide operational viewing resolution for screens of any size, including screens as small as 0.25 inches by 0.25 inches and smaller depending upon the application. In particular, in one embodiment, the light modulating layer includes a display formed of a display panel that has a plurality of transversely moveable shutters arranged into a matrix of pixel elements. The matrix is approximately one inch in width by one inch in length, with 120 columns and 120 rows, thereby providing approximately 14,400 pixels evenly distributed within the one inch by one inch display panel. Optionally, and as will be described in further detail, herein, a back light may be provided that provides a light source that directs light through the light modulating layer so that the transversely moving shutters can modulate the generated light to create an image on the display panel. A MEMS display controller may couple to the MEMS display panel to drive the display to create images. Optionally, the MEMS display controller provides multiple operation modes to drive the MEMS display in a mode suited to the application and conditions. The high optical power efficiency of the MEMS display panel can be leveraged by the MEMS display controller which, in one embodiment, dynamically sets the operating mode of the display panel as a function of available power and the demands of the application. The efficient power use and control of the devices described herein allow for additional functionality, such as WI-FI and full color video, which otherwise may draw more power than the on board power source can provide for any practical amount of time. These and other embodiments will be described in more detail with reference to the figures set forth herein.

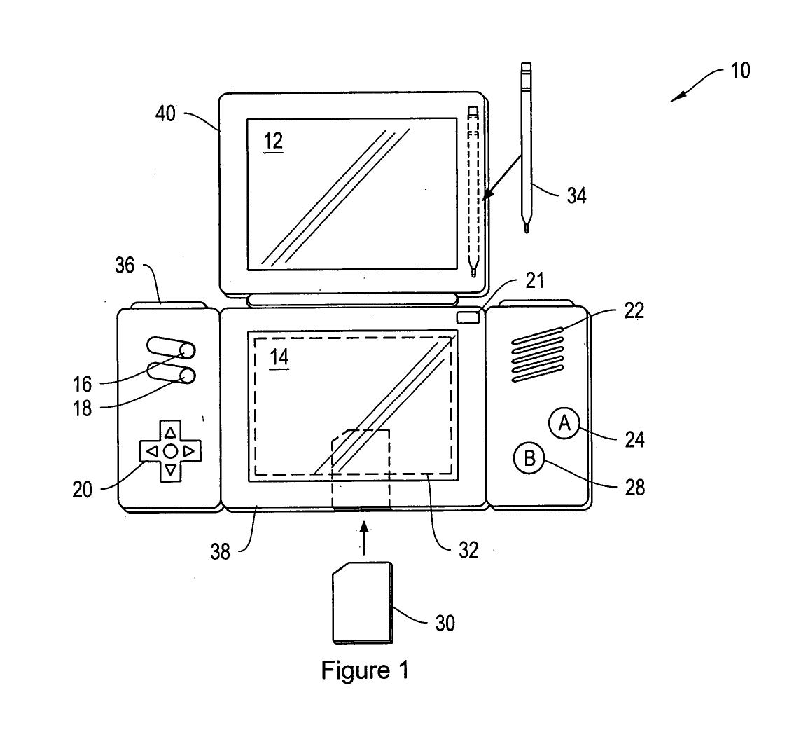

More specifically, FIG. 1 depicts a first embodiment of a system according to the invention and shows a portable handheld device 10 that includes a display 12, an optional second display 14, a display brightness control 16, a display contrast control 18, a user interface input device 20, a light level detector 21, an audio output 22, an input control 24, a second input control 28, a removable memory device 30, an optional touch screen 32 disposed over the optional display 14, an optional stylus 34, a main housing 38 an optional light level detector and a display cover housing 40. Additionally, the system may include a power plug and docking interface and interface to external peripherals through, for instances, an audio jack or USB bus or related device.

A portable hand held device may be any device that a user can conveniently carry by hand, and has an internal power supply allowing the device to be moved from one place to another. The size of a portable hand held device will vary according to its intended purpose and features and larger devices may have handles or grips and smaller devices may have wrist straps, armbands or clips for allowing the device to be more easily carried.

The display 12 comprises a MEMS display panel described in more detail below, and housed within the cover housing 40. The display 12 is recessed within the upper face of the main body of the cover housing 40 and has dimensions of approximately 2½″ in length and 1⅞″ in width including a diagonal screen dimension of about 3″. In the depicted embodiment the display 12 fits within the cover housing 40 and the cover housing 40 includes a front plate having an aperture dimensioned for providing visual access to the display 12 and having a back plate that covers the entire rear section of the display 12. The display panel 12 may sit on a rim formed around the peripheral edge of the aperture located within the back plate of the cover housing 40. An optional seal, typically a rubber gasket or plastic gasket, may be placed around that peripheral edge so that the display panel 12 is laid against the gasket and sealed in place allowing a certain amount of resilience. This seal aids in absorbing shock if the device 10 were dropped or otherwise mishandled. Typically the cover housing 40 is made of a plastic such as polystyrene, poly-vinyl chloride, or some other suitable material. Alternatively, the housing 40 may be made of metal, or any combination of plastic and metal materials. In either case the material selected will provide a housing that is sufficiently robust to protect the display panel 12 for long-term use. The housing 40 is typically about 8 inches (20 cm) in length and 4 inches (10 cm) wide with the cover housing 40 folded over the main housing 38. Device 10 illustrated in FIG. 1 has a form factor suitable for being held in one or both hands of the user during operation. This allows the device to be easily carried and in some embodiments allows one hand to hold the device while the second hand is free for, among other things, using the optional stylus 34 to input data through the optional touch screen 32.

The optional display 14 may be a second display incorporated into the portable hand held device 10 and may be used for both displaying information and, in the depicted embodiment, inputting information. To this end, the device 10 may include an optional touch screen 32 that is laid over the display panel 14. The touch screen 32 may be the type of touch screen commonly employed in computer systems for allowing a user to use touch or force to identify a location on the touch screen 32 that may be used to identify an icon or other data being displayed on display 14.

The portable device 10 further includes user interface elements such as the input device 20 depicted in FIG. 1 and the input devices 24 and 28 as well as the audio output device 22. In the depicted embodiment the input device 20 is a cross shaped directional control button that may be used for game play, or for other forms of data input. The input devices 24 and 28 are user pressable buttons that may be used to input data to the device 10. The audio output device 22 depicted in FIG. 1 may be speaker of the type capable of providing audio signals, such as sound and music, to a user to provide feedback to the user. In either case, the input devices and the output devices including the cross shaped directional control button 36 and the audio output device 22 may be used by portable device 10 to allow a user to enter data and receive data. The interface devices allow the user to interact with information being presented on either one of the displays 12 or 14. Optionally and traditionally, the cross shaped input device 20 may be used to manipulate a cursor that would be present on either one or both of the displays 12 and 14.

The power source may be a battery, fuel cell, capacitor or any other device that provides a source of power. Typically the power source is a rechargeable battery and a power regulator circuit couples to the battery to provide the voltage levels needed to run the logic chips, lamps and the display panels, as well as any other on board devices, such as WI-FI transceivers, cell phone chip sets, tuners, speakers and other accessories. It is a realization of the invention, that by using a MEMS display with transverse shutters providing low loss of optical power and by controlling the operating mode of the display, more power may be allocated for these accessories.

The light level detector 21 may be a light sensor that detects the level of ambient light. The light level detector 21 generates a level signal that the device may use for adjusting the brightness of the display. Thus, if the light level detector 21 detects low levels of ambient light, such as the level of light in a dimly lit room, the device 10 may operate the display panels 12 and 14 with low brightness. Alternatively, if the level detector 21 detects high levels of ambient light, such as the light levels present outside on a sunny day, the device 10 may dynamically change the operating mode of displays 12 and 14 to higher brightness setting capable of being seen by a user in this ambient lighting environment.

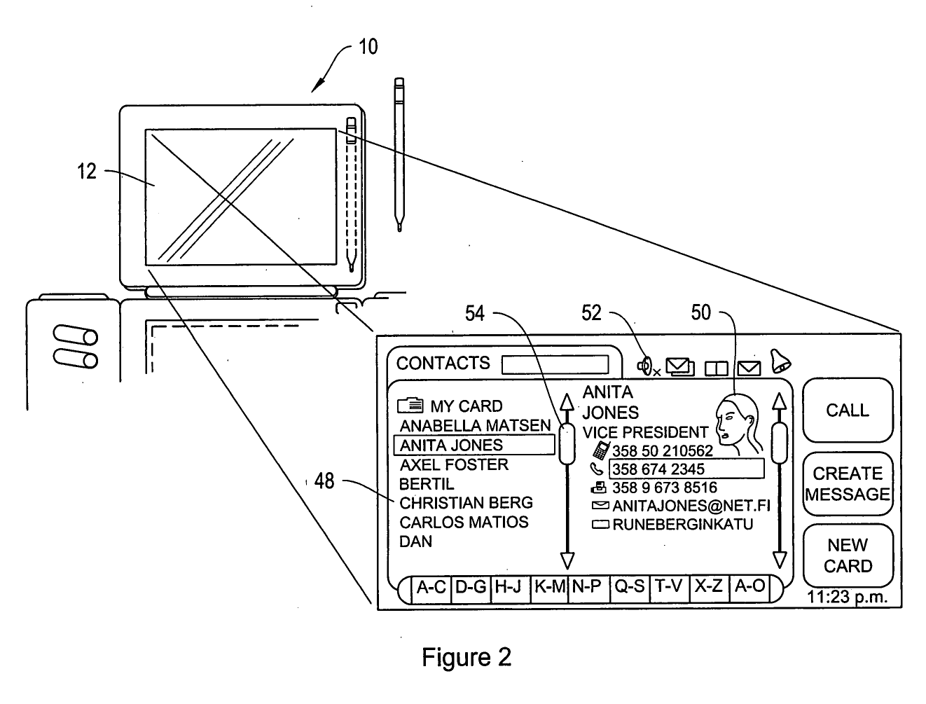

Turning to FIG. 2, there is shown in more detail the type of image that may be presented on either of display 12 for providing information to the user. In particular, FIG. 2 depicts the displays 12 or 14 which again may be 3″ in diagonal. FIG. 2 shows a plurality of different data types including images, text, and graphic symbols, as well as presenting a substantial amount of text information for a 3″ diagonal screen. In particular, FIG. 2 depicts that the display 12 can project text information such as the text 48, graphic symbols such as the depicted user widgets 52 and 54, and images such as the depicted image 50.

In the depicted embodiment, the display 12 is a high resolution pixelated screen about 2.5 inches wide and 1⅞ inches in length and having approximately 256 rows of pixels and 192 columns of pixels with about 49,152 pixels in total. The display 12 may be a color display that presents about 262,144 colors, although in other embodiments the display may have more or less colors and the amount of colors provided by the screen may be varied according to the application as will be described below. As will also be described below with reference to certain optional embodiments, the displays of the invention may also be monochromatic, typically black and white, or have a mode of operating that generates monochromatic images. In any case, as depicted in FIG. 2, the handheld device uses the display to present information to the user that can include text information, such as contact information, telephone numbers, dates and notes. Additionally, the display 12 may present image data, such as the image 50, that may be a bit map file, a jpeg file, or any other suitable image file type. Additionally, the systems and methods described herein may present video data, such as mpeg and wmv files.

The graphic controls 52 and 54 are typically graphic images generated by the handheld device 10 to offer to the user visually presented user interface controls. For example, the graphic control 52 is presented as a status flag representative of whether the handheld device has an audio output function that is muted. The user can view the graphic control 52 to learn the mute status of the related audio output device, and upon changing the mute status, the handheld device 10 can alter the graphic image 52 to a graphic symbol that represents the changed status of the mute function. Similarly, the graphic control 54 represents a slide control that can cause the information presented on the display, or at least a portion of that information, to scroll up and/or down depending upon the direction in which the control 54 is moved. The display 12 also presents information that includes content information, such as the user's data stored in the device's memory.

Thus, the display 12 is a part of the user interface of the portable device 10 and it acts as an output device for visually perceptible data and as a device for directing the user to input data. In the depicted embodiment of FIG. 2, the handheld device display 12 is used for presenting data related to a contact database. However, in other embodiments, the handheld device may be a cell phone, a smart phone, a media player, a game console, a global navigation satellite system (GNSS) receiver, a television, digital camera, handheld video camera, laptop computer or other device. In each of these embodiments, the handheld device employs the display 12 to deliver information to the user.

The display 12 includes a display panel that has a plurality of transversely movable shutters capable of modulating light to form an image on the display, such as the image depicted in FIG. 2.

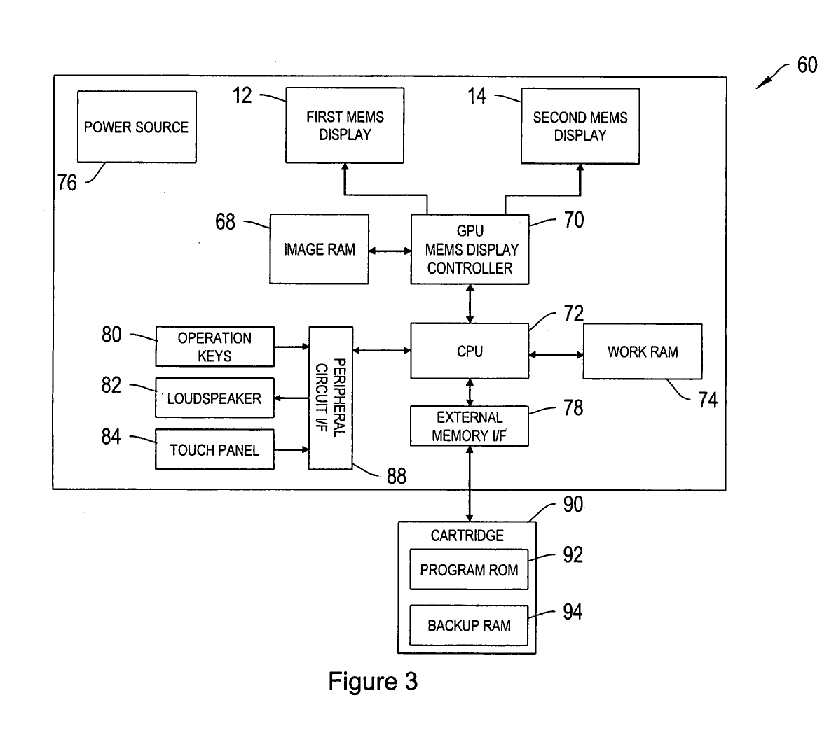

Turning to FIG. 3, a functional block diagram is presented that shows a portable handheld device 60 that includes the first MEMS display 12 and the second MEMS display 14, a graphic processing unit and MEMS display controller 70, an image RAM 68, a central processing unit (CPU) 72, work RAM 74, a power source 76, an external memory interface 78, operational keys 80, a loud speaker 82, a touch panel 84, and a peripheral circuit interface 88. Additionally, FIG. 3 shows that the device 60 can interface with the removable cartridge 90 that can include a program ROM as well as back up RAM, or that can be a memory stick.

The MEMS display panels 12 and 14 are coupled to the game processor unit and the MEMS display controller 70 (MEMS display controller). The MEMS display controller 70 depicted in FIG. 3 couples to the CPU 72 and operates, at least in part, under the control of the CPU 72. The MEMS display controller 70 couples via a bi-directional bus to the image RAM 68 which stores image and/or video data that may be displayed on either of the MEMS displays 12 or 14. In the embodiment depicted in FIG. 3, the CPU 72 couples to a plurality of user interface devices via the peripheral circuit interface 88. The peripheral circuit interface 88 couples to the operation keys 80, which may be the interface devices 20, 24 and 28 depicted in FIG. 1. The peripheral interface 88 may also couple to a loudspeaker, which may be similar to the audio output device 22 also shown in FIG. 1. An optional touch panel 84, which may be the touch panel 32 of FIG. 1, couples to the CPU 72 through the peripheral interface 88. In the depicted embodiment, the portable handheld device includes an interface 78 for an external memory device 90. The external memory device may include program instructions for directing the operation of the device and may include memory, such as the depicted program ROM and backup RAM 94. In either case, the external memory 90 may couple to the CPU via the external memory interface 78. Optionally, the system may include other elements, such as Wi-Fi transceivers, blue tooth transceivers, television and/or radio tuners and other such elements. These elements may be integrated into the device 10 and disposed within the housing 38 or may be peripheral devices that couple to the device through the interface 78, or through another interface provided for that purpose.

The CPU 72 may be a microprocessor unit such as the ARM 7, that is capable of polling the interface devices 78 and 88 to collect user input and to provide user feedback during operation. The CPU 72 is a programmable device that executes program instructions that for example may include instructions for executing a video game on the handheld device 10, using the MEMS display 12 as an output device for video information. To this end, the CPU 72 can monitor the user input devices 80 to collect information about the user's play decisions and use the play information to determine what images to present to the user via either or both of the MEMS displays 12 and 14.

To present visual information to the user, the CPU 72 can couple to the MEMS display controller 70, that may be in one embodiment, a field programmable gate array (FPGA) of the type for providing programmable logic. The MEMS display controller 70, in response to an instruction from the CPU 72, employs the RAM 68 to generate a game image to output to the first MEMS display 12 and the second MEMS display 14, and causes the generated game image to be displayed on one or both of the MEMS displays 12 and 14.

In the depicted embodiment, the MEMS display controller 70 is a graphics processor and a MEMS display controller integrated into a single programmable device, typically a field programmable gate array (FPGA). The graphic processor unit (GPU) may be a conventional GPU of the type capable of manipulating graphic images such as sprites and organizing or selecting image data within or from the RAM 68 for it to be displayed by the MEMS display controller 70 on one of or both of the MEMS displays 12 and 14.

The MEMS display controller 70 depicted in FIG. 3 is also implemented, at least in part, within the FPGA 70, but it will be apparent to those of skill in the art that the GPU and MEMS display controller may be implemented in separate programmable devices and further that any suitable type of circuit and controller may be employed and that a FPGA is merely one common embodiment of a system for implementing complex logic within a portable electronic device.

The depicted MEMS display controller 70 has multiple modes of operation for controlling each of the MEMS displays 12 and 14. As it will be described in more detail, the portable handheld devices according to the invention include display panels that are formed having a MEMS layer including a plurality of transversely movable shutters. The transversely movable shutters are capable of modulating light for the purpose of generating an image on the MEMS display. The traversely moveable shutters employed in the display panel efficiently move from at least a first position to a second position doing so at rates that enable video images on either of the MEMS display. Additionally, in certain embodiments the MEMS display panel is capable of displaying monochromatic data, typically black and white, for applications such as wrist watches, e-books, graphic still images, text, and other similar applications. The MEMS display controller 70 depicted in FIG. 3 includes a mode of operation for efficiently driving the MEMS display panels 12 and 14 to present an image using a mode of operation selected by the MEMS display controller 70 to reduce power expenditures from the power source 76 within the handheld device 10.

The MEMS display controller 70, may provide for dynamic control of the MEMS display panel, and in one embodiment, provides control, including adaptive control, over color depth by controlling the number of bits used to set color, such as 2 bits (monochromatic), 4 bits, 6 bits or more, depending upon the application and the conditions, such as user input, ambient light and available power. The MEMS display controller 70 can, in certain embodiments include a state machine within the FPGA that sets the color resolution (including monochromatic color, commonly black and white) for the power to be drawn, which can lead to substantial power savings. For example, the MEMS display controller 70 may determine that monochromatic displays are needed for a particular application, such as showing the digits of a phone number being dialed. In this mode, the MEMS display controller 70 may select two bit operation mode, that uses monochromatic imaging to display the number being dialed. However, if the application, such as a running web browser, requires color images, the MEMS display controller 70 may use 6 bit color to present the images. Optionally, the MEMS display controller 70 may process the image data stored in the image memory to determine the required depth of color and, based on that determination, adjust the number of bits used to generate the images. The MEMS display controller 70 can use time multiplexed grey scale, and use a command sequence to set color bit depth, setting color bit depth dynamically and adaptively.

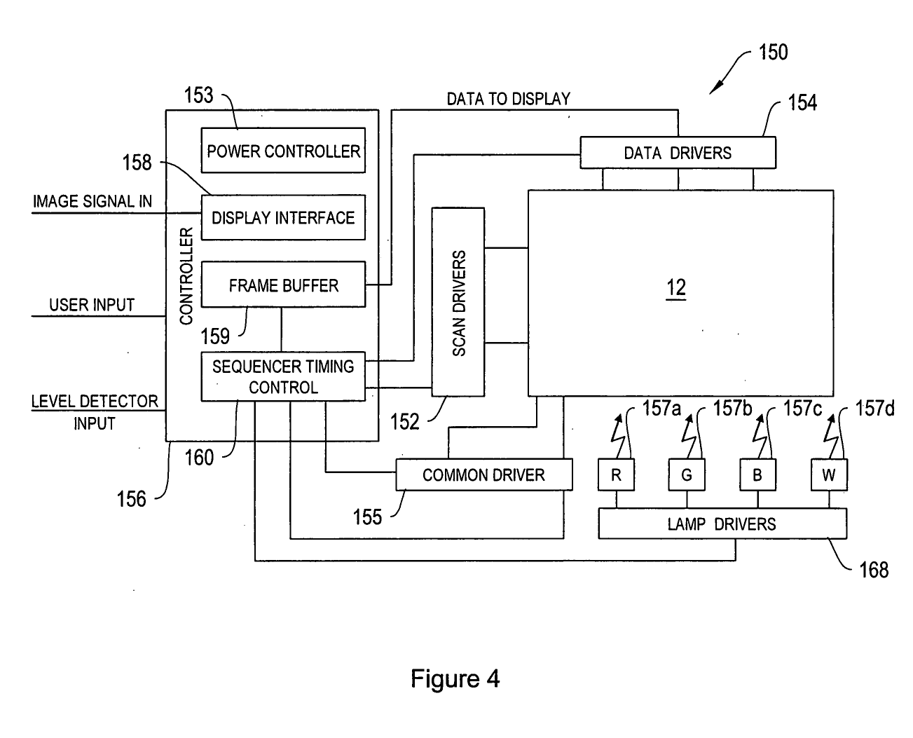

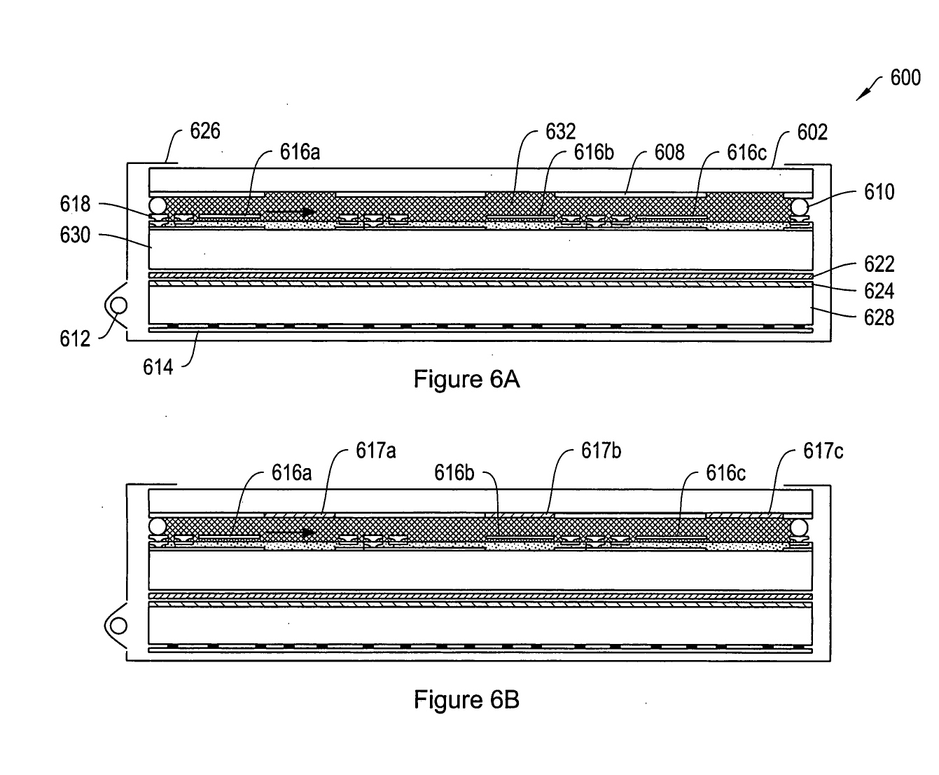

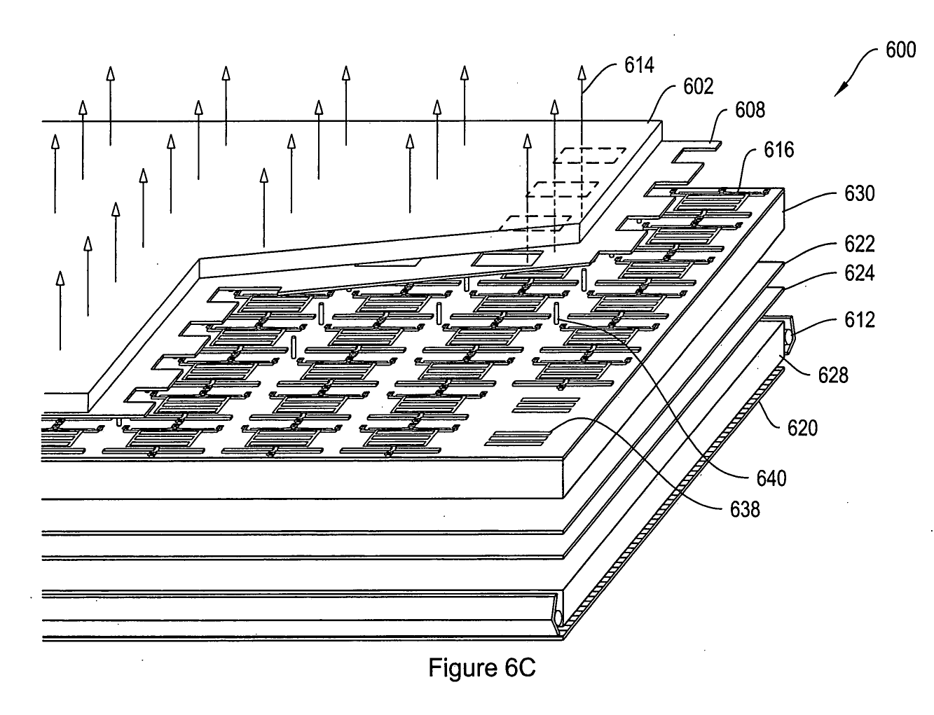

FIG. 4 is a block diagram of one embodiment of a MEMS display controller. The depicted MEMS display controller can drive and control a MEMS display panel, such as panel 12 or 14. As noted above, the portable handheld devices described herein employ a MEMS display panel that includes a plurality of transversely moveable shutters that modulate light to generate an image for the user. One embodiment of such a MEMS display is depicted in more detail in FIG. 6C, which presents an exploded view of an example MEMS display panel 600.

In particular, FIG. 6C depicts a MEMS display panel 600 that includes a cover plate 602, a black matrix 608, a plurality of shutter assemblies 616 arranged into a matrix having rows and columns, a transparent substrate 630, an enhancer film 622, a diffuser layer 624, a light conducting medium 628, a scattering and reflective layer 620 and a plurality of support posts 640.

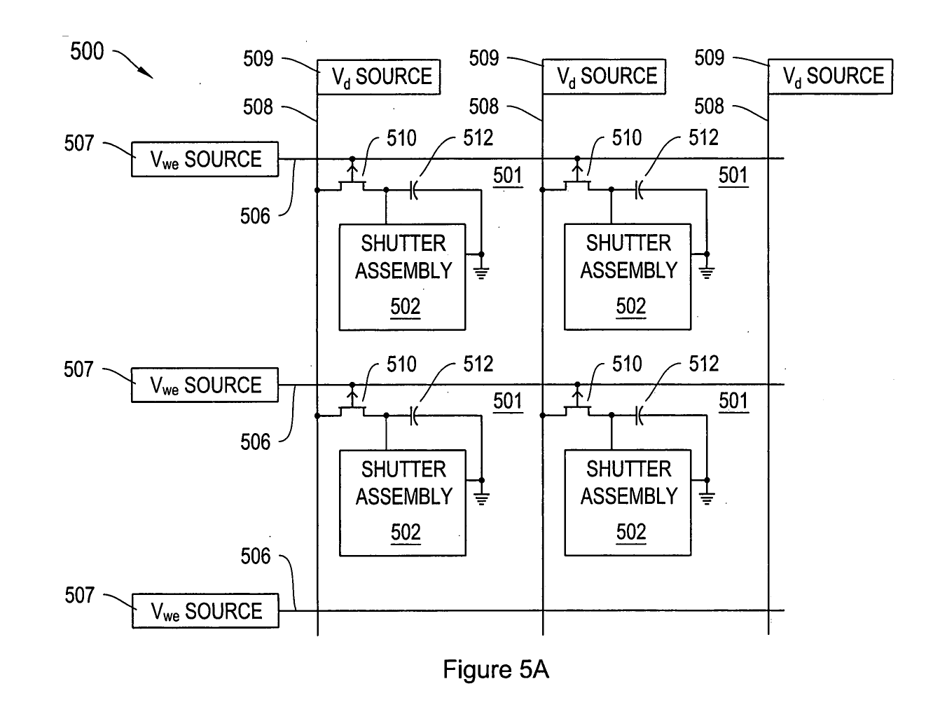

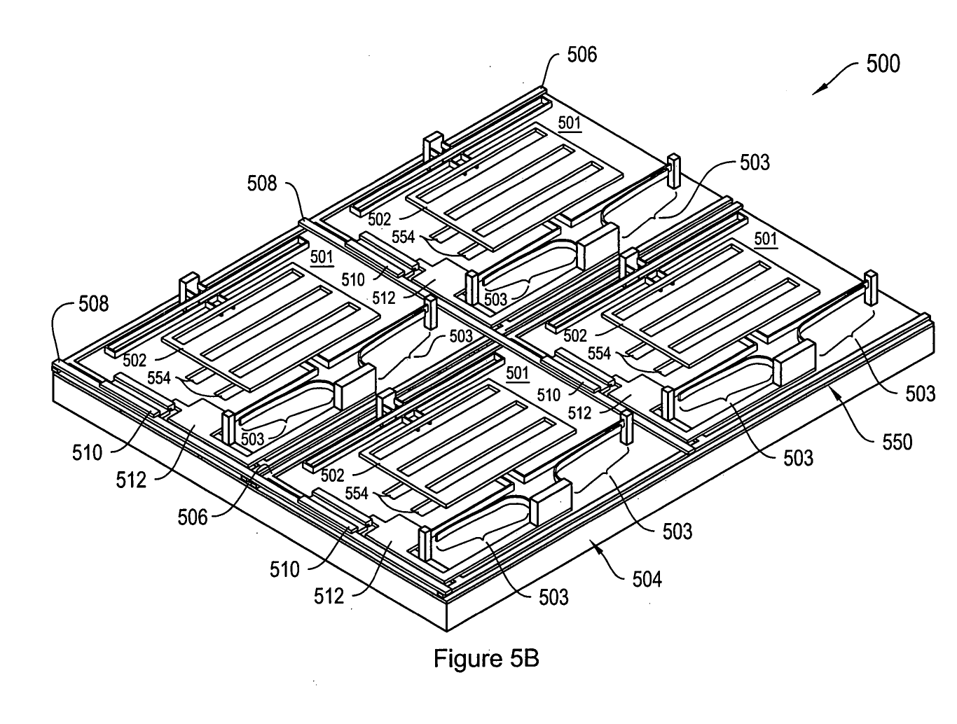

The depicted shutter assemblies 616 comprise a transversely moveable shutter and an electrostatic drive member. The shutter assemblies 616 are formed on the depicted MEMS layer that is formed on the transparent substrate 630. A plurality of conducting elements are also formed into the MEMS layer to provide a control matrix that can interface the shutters 616 with the MEMS display controller 70. An example of a control matrix is presented in FIG. 5A, however, the MEMS display controller can work with any suitable control matrix.

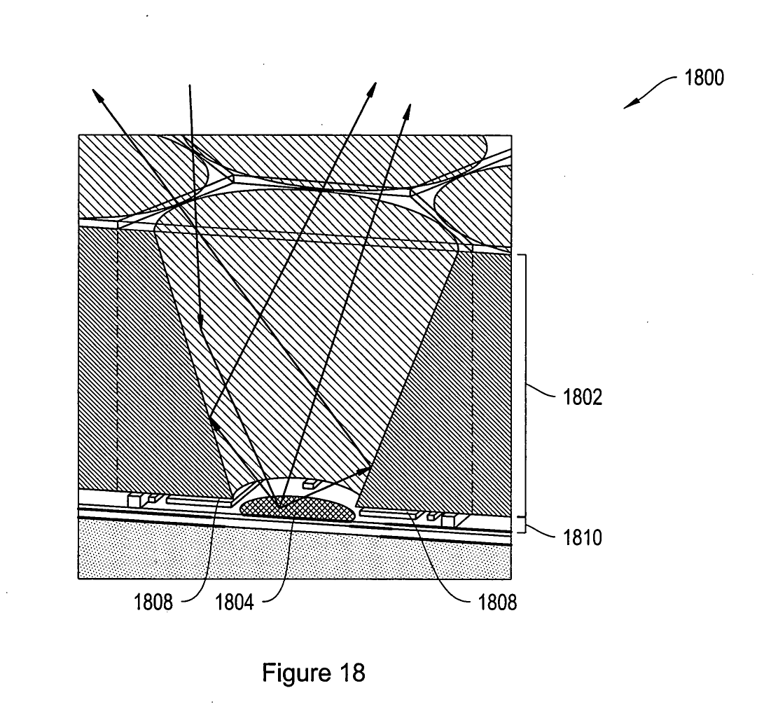

In the embodiment depicted in FIG. 6C, the shutters more transversely, preferably in a plane, so that the shutter moves over its respective Aperture 638, or at least part of the aperture 638, to modulate light being generated by the lamp (light source) 612 which is directed upwardly through the aperture 638 at least in part by the reflective/scattering surface 620. This is shown by light rays 614 propagating up through the cover plate 602. In this embodiment, the transversely moving shutters, which are described in more detail with reference to FIG. 5B, modulate light by moving transversely over the aperture 638 substantially in plane, effectively slicing through any fluid that surrounds the shutter. This slicing motion is understood to be efficient and to provide video rate switching speeds. The MEMS displays described herein are illustrative of the type of MEMS display panels that may be used with the portable hand held devices of the invention. However, these illustrated embodiments are not exhaustive and the MEMS display panels may be modified as appropriate for the intended use and for example may include front lights, color filters, shutters that modulate reflected ambient light to provide reflective or trans/reflective MEMS display panel. One example of such a reflective display is presented in FIG. 18. Specifically, FIG. 18 depicts a reflective MEMS display panel 1800 that includes lens array 1802 disposed on a shutter assembly 1810 that has a shutter 1808 that transversely moves over a reflective surface 1804 to modulate incident ambient light. Thus, the displays may vary depending on the application, they may be of different shapes and sizes, the may be QVGA or some other size and the size, pixel count and pixel density may vary according to the application.

The control matrix connected to the MEMS layer and to the shutter assemblies 616 controls the movement of the shutters. The control matrix includes a series of electrical interconnects (not shown), including a write-enable interconnect also referred to as a “scan-line interconnect,” for each row of pixels, one data interconnect for each column of pixels, and one common interconnect providing a common voltage to all pixels, or at least pixels from both multiple columns and multiples rows in the display panel 600. In response to the application of an appropriate voltage (the “write-enabling voltage, V_{we}”), the write-enable interconnect for a given row of pixels prepares the pixels in the row to accept new shutter movement instructions from the MEMS display controller. The data interconnects communicate the new movement instructions in the form of data voltage pulses. The data voltage pulses applied to the data interconnects, in some implementations, directly contribute to an electrostatic movement of the shutters. In other implementations, the data voltage pulses control switches, e.g., transistors or other non-linear circuit elements that control the application of separate actuation voltages, which are typically higher in magnitude than the data voltages, to the shutter assemblies 616. The application of these actuation voltages then results in the electrostatic movement of the shutters. To this end, a common driver 155 may be used to drive the movement of the shutters after the data voltages have been applied. The depicted common driver 155 can control one or more common signals, that is signals electrically delivered to all or a group of the shutter assemblies. These common signals can include the common write enable, common high voltage for shutter actuation, common ground. Optionally, the common driver may drive multiple line such as for example multiple common grounds that are electrically coupled to different areas of the MEMS display panel 14. It will be understood that the drivers in FIG. 4 are depicted as functional blocks, but in practice, these drivers can be implemented as multiple circuit elements and discreet components and that the actual structure will vary according to the application being addressed.

The MEMS display controller depicted in FIG. 4 includes a controller 156, a display interface 158, frame buffer 159, sequencer/timing control 160, data drivers 154, scan drivers 152, lamp drivers 168, a power controller 153 and also shown are four lamps, 157a-d that operate under independent control as light sources for the MEMS display panel 12. The lamps 157a-d have different colors (red, green, blue and white) for providing color images/video and monochromatic images/video. The lamps 157a-d are shown as separate elements, but commonly these lamps are integrated with the housing of the display panel. The MEMS display controller 150 may be comprised of programmable logic elements, such as FPGAs, and discreet circuit components. In one embodiment, the controller 156 is an FPGA device programmed to implement the power controller 153, Display Interface 158, frame buffer 159 and sequencer/timing control 160. The scan driver 152, data driver 154 and lamp driver 168 may be discreet circuit components, such as custom integrated circuits, commercially available drivers and/or discreet transistors.

The plurality of scan drivers 152 (also referred to as “write enabling voltage sources”) and plurality of data drivers 154 (also referred to as “data voltage sources”) are electrically coupled to the control matrix of display 12. The scan drivers 152 apply write enabling voltages to scan-line interconnects, such as scan line interconnects 506 depicted in FIG. 5A. The data drivers 154 apply data voltages to the data interconnects 508. In some embodiments of the MEMS display controller, the data drivers 154 are configured to provide analog data voltages to the shutter assemblies, especially where the gray scale of the image is to be derived in an analog fashion. In analog operation the shutter assemblies 616 are designed such that when a range of intermediate voltages is applied through the data interconnects 508 there results a range of intermediate open states in the shutters and therefore a range of intermediate illumination states or gray scales in the image.

In other cases the data drivers 154 are configured to apply only a reduced set of 2, 3, or 4 digital voltage levels to the control matrix. These voltage levels are designed to set, in digital fashion, either an open state, a closed state or an intermediate state to each of the shutters.

The scan drivers 152 and the data drivers 154 are connected to digital controller circuit 156 (also referred to as the “controller 156”). The controller includes a display interface 158 which processes incoming image signals into a digital image format appropriate to the spatial addressing and the gray scale capabilities and mode of operation of the display 12. The pixel location and gray scale data of each image is stored in a frame buffer 159 so that the data can be fed out as needed to the data drivers 154. The data is sent to the data drivers 154 in serial or parallel transmission, organized in predetermined sequences grouped by rows and by image frames. The data drivers 154 can include series to parallel data converters, level shifting, and for some applications digital to analog voltage converters.

All of the drivers (e.g., scan drivers 152, data drivers 154, actuation driver 153 and global actuation driver 155 (not shown)) for different display functions are time-synchronized by a timing-control 160 in the controller 156. Timing commands coordinate the independent, dependent or synchronized illumination of red, green, blue and white lamps 157a-d and via lamp drivers 168, the write-enabling and sequencing of specific rows of the array of pixels, the output of voltages from the data drivers 154, and for the output of voltages that provide for shutter actuation.

The controller 156 may include program logic to implement a color image generator that determines the sequencing or addressing scheme by which each of the shutters in the array can be re-set as appropriate to a new image. New images can be set at periodic intervals. For instance, for video displays, the color images or frames of the video are refreshed at frequencies ranging from 10 to 1000 Hertz although the frequency can vary based on the application. In some embodiments the setting of an image frame is synchronized with the illumination of a backlight such that alternate image frames are illuminated with an alternating series of colors, such as red, green, blue, and white. The image frames for each respective color is referred to as a color sub-frame. The FPGA can have program logic to implement a light controller to carry out the sequential activation of the LEDs. In this method, referred to as the field sequential color method, if the color sub-frames are alternated at frequencies in excess of 20 Hz and preferably 180 Hz, the user perceives an average of the alternating frame images and sees an image having a broad and continuous range of colors. The duration of the color subframe can vary depending upon the application, and by varying the duration of the frametime image parameters such as brightness, the color saturation and depth may be controlled and the power used may be controlled as well. For example, the controller 156 can adjust the color depth of images being displayed to control power being used by the display, with the color depth selected as a function of the image being displayed. In a cell phone application, the controller 156 can identify an image signal incoming to the controller 156 representative of text. For example, when the user uses the keypad interface, the program logic can determine that a phone number is being entered and is to be displayed as an image. In this state, the controller 156 enters a monochromatic mode of operation. The controller 156 activates the drivers to set up the shutters to display a monochromatic image of the phone number and activates the light source in a low frequency or steady state mode as sequencing through multiple alternate image formats for different color components is not required in monochromatic mode. This reduces power use avoiding spending power on driving the shutters to alternate image formats and avoids driving the LEDs at a switching rate or with a frame timing that uses power. A similar mode of operation may be adapted by reducing the color depth when possible and therefore reducing the number of times the shutters need to be driven to set up alternate images and allowing a longer timeframe for driving the LEDs. The color image generation may be carried out by the controller 156, or separate logic devices may be used for the color image generator, and both are within the scope of the invention.

In an alternative embodiment, the MEMS display 12 includes at least one color filter layer and typically the color filter layer places colored filters in the path of light being modulated by a group of respective shutters. To this end, the MEMS display may have a color filter layer, such as the color filter layer depicted in FIG. 6B which shows a color filter layer disposed between the cover plate 602 and the shutters 616. In particular, the color filter layer is integrated into the black matrix 608 and provides a red filter segment 617a over shutter assembly 616a, a blue filter segment 617b over shutter assembly 616b, and a green filter segment 617c over shutter assembly 616c. The three shutter assemblies 616a-616c can be operated by the MEMS display controller 70 separately and is a coordinated movement process that sets up the image over the three shutter assemblies 616a-c, one shutter being used for each color component of the image. The three shutter assemblies work together to provide a pixel for the display. To this end the MEMS display controller 70 can generate a red image, a blue image and a green image, each of which is stored in the frame buffer 159 and sent out to the scan driver 152 and data drivers 154. In this embodiment, only the white lamp 157d is needed and color arises from the color filter layer. In other embodiment, other filter colors and filter arrangements may be used.

If the display apparatus 100 is designed for the digital switching of shutters between open and closed states, the controller 156 can control the addressing sequence and/or the time intervals between image frames to produce images with appropriate gray scale. The process of generating varying levels of grayscale by controlling the amount of time a shutter is open in a particular frame is referred to as time division gray scale. In one embodiment of time division gray scale, the controller 156 determines the time period or the fraction of time within each frame that a shutter is allowed to remain in the open state, according to the illumination level or gray scale desired of that pixel. In another embodiment of time division gray scale, the frame time is split into, for instance, 15 equal time-duration sub-frames according to the illumination levels appropriate to a 4-bit binary gray scale. The controller 156 then sets a distinct image into each of the 15 sub-frames. The brighter pixels of the image are left in the open state for most or all of the 15 sub-frames, and the darker pixels are set in the open state for only a fraction of the sub-frames. In another embodiment of time-division gray scale, the controller circuit 156 alters the duration of a series of sub-frames in proportion to the bit-level significance of a coded gray-scale word representing an illumination value. That is, the time durations of the sub-frames can be varied according to the binary series 1,2,4,8 . . . The shutters 108 for each pixel are then set to either the open or closed state in a particular sub-frame according to the bit value at a corresponding position within the binary word for its intended gray level.

A number of hybrid techniques are available for forming gray scale which combine the time division techniques described above with the use of either multiple shutters per pixel or via the independent control of backlight intensity. These techniques are described further below.

Addressing the control matrix, i.e., supplying control information to the array of pixels, is, in one implementation, accomplished by a sequential addressing of individual lines, sometimes referred to as the scan lines or rows of the matrix. By applying Vwe to the write-enable interconnect for a given scan line and selectively applying data voltage pulses Vd to the data interconnects 508 for each column, the control matrix can control the movement of each shutter in the write-enabled row. By repeating these steps for each row of pixels in the MEMS display 12, the control matrix can complete the set of movement instructions to each pixel in the MEMS display 12.

In one alternative implementation, the control matrix applies Vwe to the write-enable interconnects of multiple rows of pixels simultaneously, for example, to take advantage of similarities between movement instructions for pixels in different rows of pixels, thereby decreasing the amount of time needed to provide movement instructions to all pixels in the MEMS display 12. In another alternative implementation, the rows are addressed in a non-sequential, e.g., in a pseudo-randomized order, to minimize visual artifacts that are sometimes produced, especially in conjunction with the use of a coded time division gray scale.

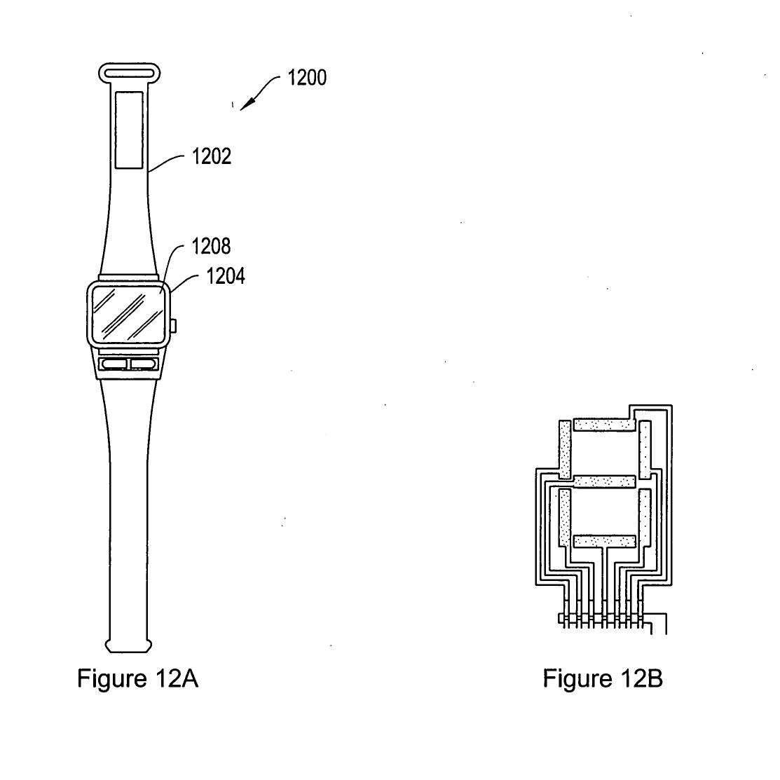

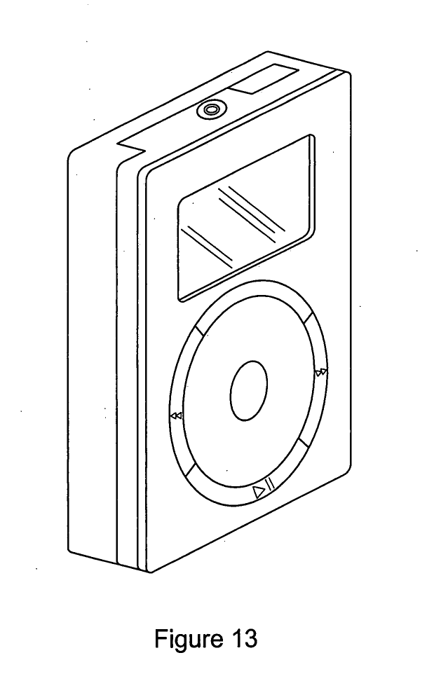

In alternative embodiments, the array of pixels and the control matrices that control the pixels incorporated into the array may be arranged in configurations other than rectangular rows and columns. For example, the pixels can be arranged in hexagonal arrays or curvilinear rows and columns and as segmented displays as depicted in FIG. 12B. In general, as used herein, the term scan-line shall refer to any plurality of pixels that share a write-enabling interconnect.

Control Matrices and Methods of Operation Thereof

FIG. 5A is a conceptual diagram of a control matrix 500 suitable for inclusion in the display panel 12 for addressing an array of pixels. FIG. 5B is an isometric view of a portion of an array of pixels including the control matrix 500. Each pixel 501 includes an elastic shutter assembly 502 controlled by an actuator 503.

The control matrix 500 is fabricated as a diffused or thin-film-deposited electrical circuit on the surface of a substrate 504 on which the shutter assemblies 502 are formed. The control matrix 500 includes a scan-line interconnect 506 for each row of pixels 501 in the control matrix 500 and a data-interconnect 508 for each column of pixels 501 in the control matrix 500. Each scan-line interconnect 506 electrically connects a write-enabling voltage source 507 to the pixels 501 in a corresponding row of pixels 501. Each data interconnect 508 electrically connects a data voltage source, (“Vd source”) 509 to the pixels 501 in a corresponding column of pixels. In control matrix 500, the data voltage Vd provides the majority of the energy necessary for actuation. Thus, the data voltage source 509 also serves as an actuation voltage source. In alternate embodiments the actuation voltage, Vd, can be a common interconnections to the cells of the display.

For each pixel 501 or for each shutter assembly in the array, the control matrix 500 includes a transistor 510 and an optional capacitor 512. The gate of each transistor is electrically connected to the scan-line interconnect 506 of the row in the array in which the pixel 501 is located. The source of each transistor 510 is electrically connected to its corresponding data interconnect 508. The shutter assembly 502 includes an actuator with two electrodes. The two electrodes have significantly different capacitances with respect to the surroundings. The transistor connects the data interconnect 508 to the actuator electrode having the lower capacitance.

More particularly the drain of each transistor 510 is electrically connected in parallel to one electrode of the corresponding capacitor 512 and to the lower capacitance electrode of the actuator. The other electrode of the capacitor 512 and the higher capacitance electrode of the actuator in shutter assembly 502 are connected to a common or ground potential. In operation, to form an image, the MEMS controller 70 drives the control matrix 500 to write-enable each row in the array in sequence by applying Vwe to each scan-line interconnect 506 in turn. For a write-enabled row, the application of Vwe to the gates of the transistors 510 of the pixels 501 in the row allows the flow of current through the data interconnects 508 through the transistors to apply a potential to the actuator of the shutter assembly 502. While the row is write-enabled, data voltages Vd are selectively applied to the data interconnects 508. In implementations providing analog gray scale, the data voltage applied to each data interconnect 508 is varied in relation to the desired brightness of the pixel 501 located at the intersection of the write-enabled scan-line interconnect 506 and the data interconnect 508. In implementations providing digital control schemes, the data voltage is selected to be either a relatively low magnitude voltage (i.e., a voltage near ground) or to meet or exceed Vat (the actuation threshold voltage). In response to the application of Vat to a data interconnect 508, the actuator in the corresponding shutter assembly 502 actuates, opening the shutter in that shutter assembly 502. The voltage applied to the data interconnect 508 remains stored in the capacitor 512 of the pixel even after the control matrix 500 ceases to apply Vwe to a row. FIG. 5B shows a moveable contact that is formed on the light modulating layer and is couple to the control matrix. This moveable contact will move toward the moveable shutter and can reduce the voltage that needs to applied to the shutter to cause it to move. Contacts like this can be put on each actuator to reduce the voltage needed to move the shutter in either direction. It is not necessary, therefore, to wait and hold the voltage Vwe on a row for times long enough for the shutter assembly 502 to actuate; such actuation can proceed after the write-enabling voltage has been removed from the row. The voltage in the capacitors 510 in a row remain substantially stored until an entire video frame is written, and in some implementations until new data is written to the row.

The control matrix 500 can be manufactured through use of the following sequence of processing steps:

First an aperture layer 550 is formed on a substrate 504. If the substrate 504 is opaque, such as silicon, then the substrate 504 serves as the aperture layer 550, and aperture holes 554 are formed in the substrate 504 by etching an array of holes through the substrate 504. If the substrate 504 is transparent, such as glass, then the aperture layer 550 may be formed from the deposition of a light blocking layer on the substrate 504 and etching of the light blocking layer into an array of holes. The aperture holes 554 can be generally circular, elliptical, polygonal, serpentine, or irregular in shape. As described in U.S. patent application Ser. No. 11/218,690, filed on Sep. 2, 2005, if the light blocking layer is also made of a reflective material, such as a metal, then the aperture layer 550 can act as a mirror surface which recycles non-transmitted light back into an attached backlight for increased optical efficiency. Reflective metal films appropriate for providing light recycling can be formed by a number of vapor deposition techniques including sputtering, evaporation, ion plating, laser ablation, or chemical vapor deposition. Metals that are effective for this reflective application include, without limitation, Al, Cr, Au, Ag, Cu, Ni, Ta, Ti, Nd, Nb, Si, Mo, Rh and/or alloys thereof. Thicknesses in the range of 30 nm to 1000 nm are sufficient.

Second, an intermetal dielectric layer is deposited in blanket fashion over the top of the aperture layer metal 550.

Third, a first conducting layer is deposited and patterned on the substrate. This conductive layer can be patterned into the conductive traces of the scan-line interconnect 506. Any of the metals listed above, or conducting oxides such as indium tin oxide, can have sufficiently low resistivity for this application. A portion of the scan line interconnect 506 in each pixel is positioned to so as to form the gate of a transistor 510.

Fourth, another intermetal dielectric layer is deposited in blanket fashion over the top of the first layer of conductive interconnects, including that portion that forms the gate of the transistor 510. Intermetal dielectrics sufficient for this purpose include SiO2, Si3N4, and Al2O3 with thicknesses in the range of 30 nm to 1000 nm.

Fifth, a layer of amorphous silicon is deposited on top of the intermetal dielectric and then patterned to form the source, drain and channel regions of a thin film transistor active layer. Alternatively this semiconducting material can be polycrystalline silicon.

Sixth, a second conducting layer is deposited and patterned on top of the amorphous silicon. This conductive layer can be patterned into the conductive traces of the data interconnect 508. The same metals and/or conducting oxides can be used as listed above. Portions of the second conducting layer can also be used to form contacts to the source and drain regions of the transistor 510.

Capacitor structures such as capacitor 512 can be built as plates formed in the first and second conducting layers with the intervening dielectric material. Seventh, a passivating dielectric is deposited over the top of the second conducting layer. Eighth, a sacrificial mechanical layer is deposited over the top of the passivation layer. Vias are opened into both the sacrificial layer and the passivation layer such that subsequent MEMS shutter layers can make electrical contact and mechanical attachment to the conducting layers below.

Ninth, a MEMS shutter layer is deposited and patterned on top of the sacrificial layer. The MEMS shutter layer is patterned with shutters 502 as well as actuators 503 and is anchored to the substrate 504 through vias that are patterned into the sacrificial layer. The pattern of the shutter 502 is aligned to the pattern of the aperture holes 554 that were formed in the first aperture layer 550. The MEMS shutter layer may be composed of a deposited metal, such as Au, Cr or Ni, or a deposited semiconductor, such as polycrystalline silicon or amorphous silicon, with thicknesses in the range of 300 nanometers to 10 microns. Optionally, the shutter may be a composite shutter comprising a layer of a metal between two other layers, such as two layers of amorphous silicon.

Tenth, the sacrificial layer is removed such that components of the MEMS shutter layer become free to move in response to voltages that are applied across the actuators 503. Eleventh, the sidewalls of the actuator 503 electrodes are coated with a dielectric material to prevent shorting between electrodes with opposing voltages.

Many variations on the above process are possible. For instance the reflective aperture layer 550 of step 1 can be combined into the first conducting layer. Gaps are patterned into this conducting layer to provide for electrically conductive traces within the layer, while most of the pixel area remains covered with a reflective metal. In another embodiment, the transistor 510 source and drain terminals can be placed on the first conducting layer while the gate terminals are formed in the second conducting layer. In another embodiment the semiconducting amorphous or polycrystalline silicon is placed directly below each of the first and second conducting layers. In this embodiment vias can be patterned into the intermetal dielectric so that metal contacts can be made to the underlying semiconducting layer. Further, the devices described herein can work with many different control matrices, including active and/or passive matrices.

As described in relation to FIG. 5B, the actuators included in the shutter assembly may be designed to be mechanically bi-stable. Alternatively, the actuators can be designed to have only one stable position. That is, absent the application of some form of actuation force, such actuators return to a predetermined position, either open or closed. In such implementations, the shutter assembly includes a single actuation electrode, which, when energized, causes the actuator to push or pull the shutter out of its stable position. The MEMS display controller 70 can drive the shutters individually, in groups or universally. To this end, in one embodiment, the MEMS display controller 70 includes program logic to provide a sync controller that generates a sync pulse to move all or at least a group of shutters in the display to a selected condition or state. A timer implemented in the FPGA can set timing intervals for driving the sync pulse, as well as for driving other timed operations, such as but not limited to, timeframes for field sequential color operations, which can set up signals for driving the lamps and the shutters. Additionally, the FPGA timer can monitor the user input devices to change the state of the display, typically to a lower power state, if a predetermined time interval such as 30 seconds, has passed since the user activated an input device.

Display Panels

FIG. 6A is a cross-sectional view of one embodiment of a shutter-based light modulation panel 600 suitable for use with handheld portable devices described herein. The display panel 600 includes an optical cavity disposed beneath the light modulating layer 618, a light source 612, a light modulation layer 618, and a cover plate 602. The optical cavity includes a rear-facing reflective surface in the light modulation array 618, a light guide 628, a front-facing rear-reflective surface 614, a diffuser 624, and a brightness enhancing film 622.

The space between the light modulation array 618 and the cover plate 602 is filled with a lubricant 632. The cover plate 602 is attached to the shutter assembly with an epoxy 625, such as EPO-TEK B9021-1, sold by Epoxy Technology, Inc. The epoxy also serves to seal in the lubricant 624.

A sheet metal or molded plastic assembly bracket 626 holds the cover plate 602, the light modulation layer 618, and the optical cavity together around the edges. The assembly bracket 626 is fastened with screws or indent tabs to add rigidity to the combined device. In some implementations, the light source 612 is formed in place by an epoxy potting compound.

The display panel 600 may be seated into a housing, typically seating the plastic assembly bracket against one or more panel supports within the housing. In one embodiment, the panel support may be a molded plastic sidewall that is dimensioned to support the peripheral edge of the display panel 600. A resilient gasket may be placed over the molded sidewall to provide shock protection and the panel may be bonded to the gasket.

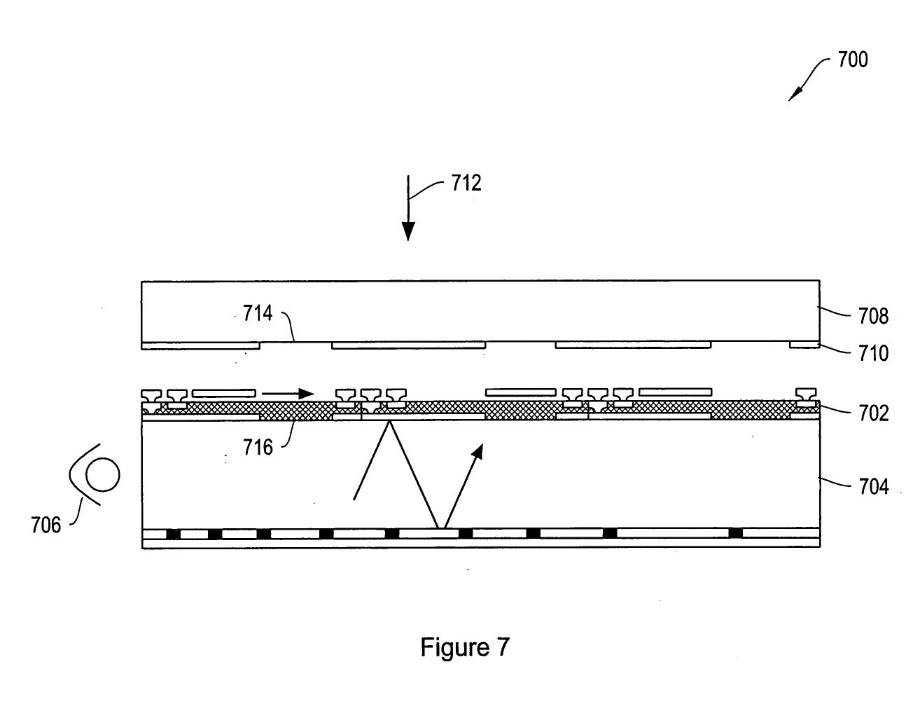

FIG. 7 is a cross sectional view of a shutter-based spatial light modulator 700, according to the illustrative embodiment of the invention. The shutter-based spatial light modulator 700 includes a light modulation array 702, an optical cavity 704, and a light source 706. In addition, the spatial light modulator includes a cover plate 708.

The cover plate 708 serves several functions, including protecting the light modulation array 702 from mechanical and environmental damage. The cover plate 708 is a thin transparent plastic, such as polycarbonate, or a glass sheet. The cover plate can be coated and patterned with a light absorbing material, also referred to as a black matrix 710. The black matrix can be deposited onto the cover plate as a thick film acrylic or vinyl resin that contains light absorbing pigments. Optionally, a separate layer may be provided.

The black matrix 710 absorbs substantially all incident ambient light 712 ambient light is light that originates from outside the spatial light modulator 700, from the vicinity of the viewer—except in patterned light-transmissive regions 714 positioned substantially proximate to light-transmissive regions 716 formed in the optical cavity 704. The black matrix 710 thereby increases the contrast of an image formed by the spatial light modulator 700. The black matrix 710 can also function to absorb light escaping the optical cavity 704 that may be emitted, in a leaky or time-continuous fashion.

In one implementation, color filters, for example, in the form of acrylic or vinyl resins are deposited on the cover plate 708. The filters may be deposited in a fashion similar to that used to form the black matrix 710, but instead, the filters are patterned over the open apertures light transmissive regions 716 of the optical cavity 704. The resins can be doped alternately with red, green, blue or other pigments.

The spacing between the light modulation array 702 and the cover plate 708 is less than 100 microns, and may be as little as 10 microns or less. The light modulation array 702 and the cover plate 708 preferably do not touch, except, in some cases, at predetermined points, as this may interfere with the operation of the light modulation array 702. The spacing can be maintained by means of lithographically defined spacers or posts, 2 to 20 microns tall, which are placed in between the individual right modulators in the light modulators array 702, or the spacing can be maintained by a sheet metal spacer inserted around the edges of the combined device.

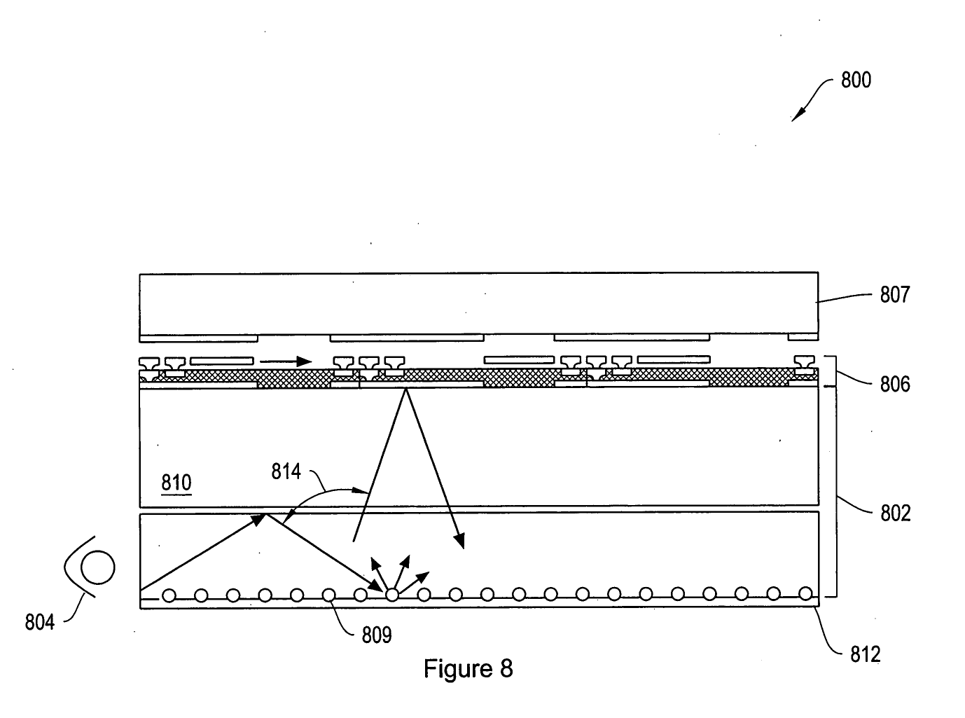

FIG. 8 is a cross sectional view of a shutter-based spatial light modulator 800, according to an illustrative embodiment of the invention. The shutter-based spatial light modulator 800 includes an optical cavity 802, a light source 804, and a light modulation layer 806. In addition, the shutter-based spatial light modulator 804 includes a cover plate 807, such as the cover plate 708 described in relation to FIG. 7. The optical cavity 802, in the shutter-based spatial light modulator 800, includes a light guide 808 and the rear-facing portion of the light modulation array 806. The light modulation array 806 is formed on its own substrate 810. Both the light guide 808 and the substrate 810 each have front and rear sides. The light modulation array 806 is formed on the front side of the substrate 810. A front-facing, rear-reflective surface 812, in the form of a second metal layer, is deposited on the rear side of the light guide 808 to form the second reflective surface of the optical cavity 802. Alternatively, the optical cavity 802 includes a third surface located behind and substantially facing the rear side of the light guide 808. In such implementations, the front-facing, rear-reflective surface 812 is deposited on the third surface facing the front of the spatial light modulator 800, instead of directly on the rear side of the light guide 808. The light guide 808 includes a plurality of light scattering elements 809 distributed in a predetermined pattern on the rear-facing side of the light guide 808 to create a more uniform distribution of light throughout the optical cavity.

In one implementation, the light guide 808 and the substrate 810 are held in intimate contact with one another. They are preferably formed of materials having similar refractive indices so that reflections are avoided at their interface. In another implementation small standoffs or spacer materials keep the light guide 808 and the substrate 810 a predetermined distance apart, thereby optically de-coupling the light guide 808 and substrate 810 from each other. The spacing apart of the light guide 808 and the substrate 810 results in an air gap 813 forming between the light guide 808 and the substrate 810. The air gap promotes total internal reflections within the light guide 808 at its front-facing surface, thereby facilitating the distribution of light 814 within the light guide before one of the light scattering elements 809 causes the light 814 to be directed toward the light modulator array 806 shutter assembly. Alternatively, the gap between the light guide 808 and the substrate 810 can be filled by a vacuum, one or more selected gasses, or a liquid.

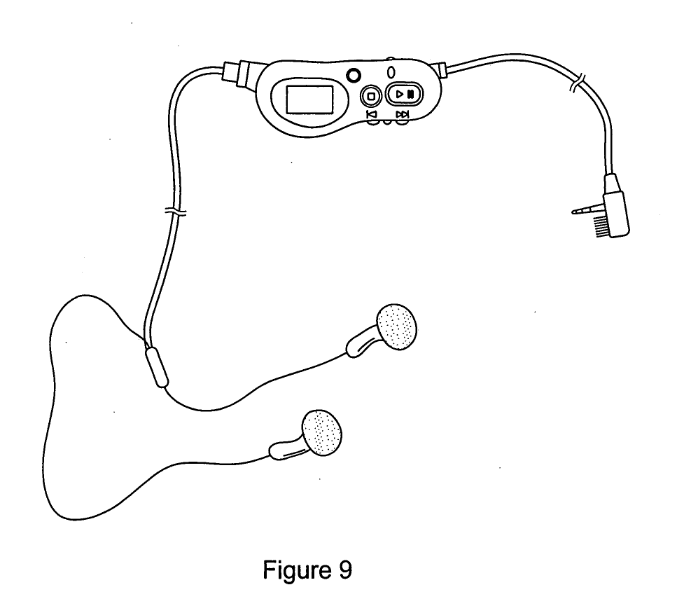

FIG. 9 depicts an embodiment of the invention wherein the portable handheld device comprises a media player having a display located within the media player and capable of presenting graphic and text information to the user. More particularly, the embodiment of FIG. 9 depicts an MP3 player of the type commonly employed for listening to music stored on digital media. In the depicted embodiment the housing is adapted to be held within the hand of the user or clipped to the user's clothing to allow for hands free transport of the device. The user interface includes a plurality of buttons located on the exterior of the housing and the display panel. The MP3 player depicted in FIG. 9 may include a display controller similar to the display controller depicted in FIG. 4. The display controller may have modes of operation capable of reducing power draw employed to present images on the display thereby prolonging the useable life of the onboard power source.

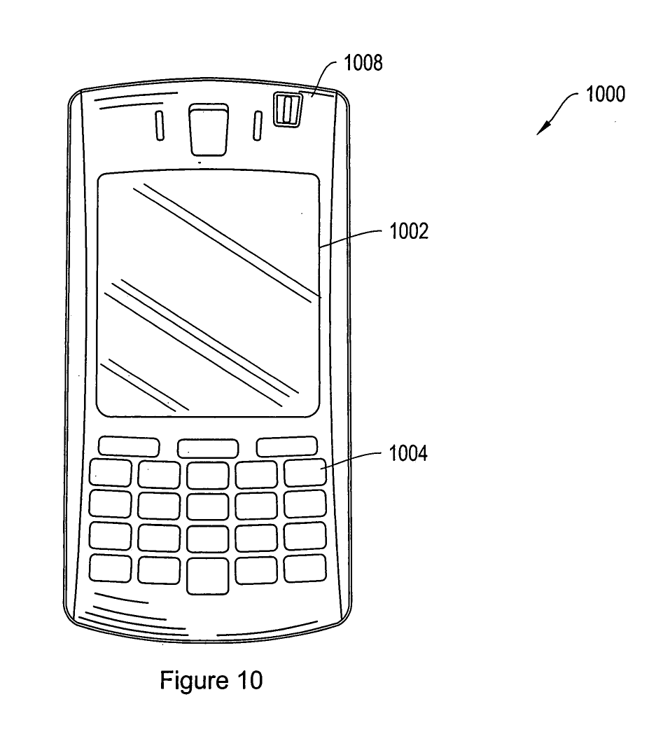

FIG. 10 depicts another application of the systems and methods described herein. In particular, FIG. 10 depicts a smart phone handheld portable device 1000 having a housing 1008, a display panel 1002, and a user interface device depicted as the keypad 1004. The smart phone handheld portable device 1000 includes a MEMS display panel that may be comparable to the above described MEMS display panels and has a MEMS display controller comparable to the controller described above with reference to the device 10 shown in FIG. 1. Optionally, the MEMS display controller of the system 1000 may include an optional power reserve mode wherein the power controller 153 of the MEMS display controller 150 determines that the power source is running low or has dropped below a predetermined threshold value. In such a mode of operation, which may be optionally user selectable, the MEMS display controller 150 operates in a low power mode to conserve power for the primary function of the smart phone device 1000 which is typically cellular communication. To this end, the MEMS display controller 150 may display image signals as monochromatic, typically black and white, static still signals on the display 1002. In the way, the display controller will deactivate field sequential color operations and use the while LED 157d for the purpose of illuminating the display 1002. The power controller 153 may adjust the amplitude at which the while LED 157b is driven, selecting a low power mode of operation that drives the white LED 157d with a constant DC voltage that is sufficient to illuminate the display. Commercially available white LED devices operate in the 10 to 30 milliwatt range providing minimal draw from the power source 76.

The depicted smartphone may also have a touch sensitive screen as described above. The touch screen may be a commercially available touch screen that overlays the MEMS display panel, or at least a section of that panel. In this embodiment, the cover plate of the MEMS display panel may have a thickness selected to prevent an inward deflection of the display panel when the user presses downwardly with a finger or stylus. The thickness will vary depending upon the material, and can range from 2 mm to 500 mm. Additionally, a support, such as the posts 640, may be positioned between the moveable shutters and the cover plate to keep the cover plate spaced away from the shutters. The optional fluid lubricant also provides a hydraulic support that reduces inward deflection of the cover plate toward the moveable shutters. The MEMS display panel can avoid the ripple effect that touch sensitive LCD screens suffer from and provide better resolution during data input.

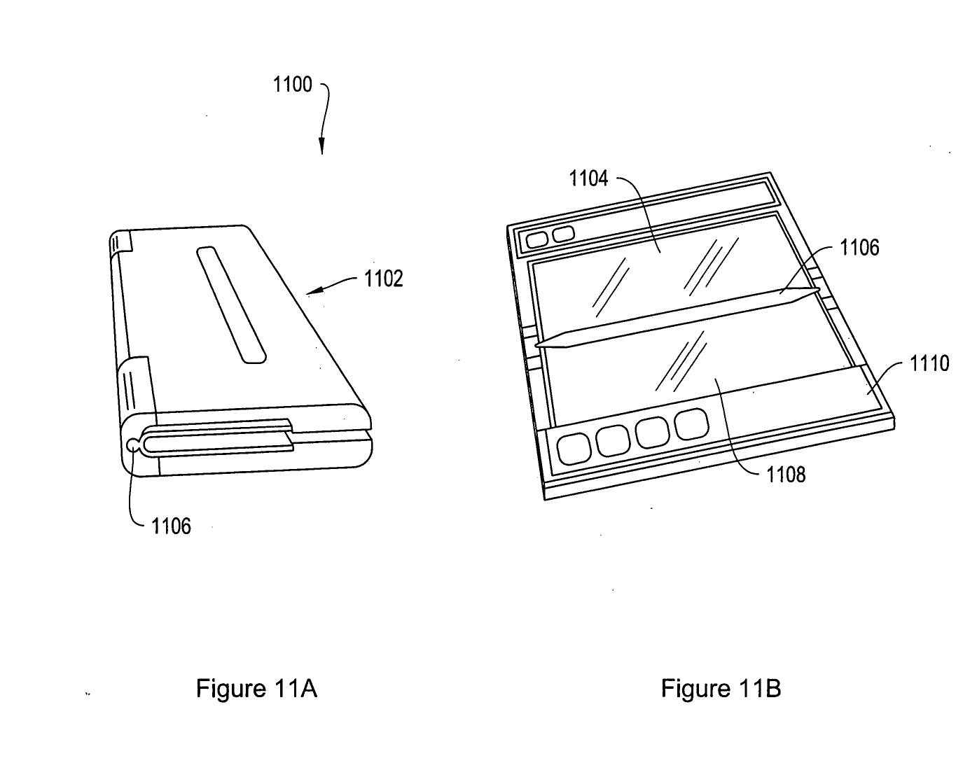

Turning to FIG. 11, further optional embodiment of the invention is shown. In particular, an e-book application is depicted where the e-book device is shown in FIG. 11A as being in a closed position and being in an open position in FIG. 11B. An e-book device is generally understood as an electronic display device capable of presented text to a user by reading a digital media device that stores the text, which may be a novel, newspaper, or other information, onto a display. In the embodiment depicted in FIGS. 11A and 11B the e-book 1100 includes a housing, 1102 that has a hinge 1106 for allowing one half of the housing to close over the second half of the housing. As further depicted in FIG. 11B, the e-book 1100 may have a first panel 1104 and a second panel 1108. A keypad 1110 can provide a series of user input devices that the user can use for manipulating which images appear on either of the screens 1104 or 1108.

In the embodiment depicted in FIGS. 11A and 11B, the e-book portable handheld device may have a MEMS display panel comparable to the MEMS display panels discussed above and may have a MEMS display controller comparable to the MEMS display controllers described as well above. The e-book A1100 is typically operated in a monochromatic mode where the MEMS display controller uses a white LED to drive static black and white images of text information to the user. In certain embodiments, color images such as a book cover or an image from the book may be displayed to the user as part of the content stored on the digital media, and in those instances the MEMS display controller may use field sequential color generation techniques such as those described above, to generate a color image on either of the display panels 1104 and 1108. The MEMS display controller may have a monochromatic mode of operation for generation static still images that the user pages through by using the user interface devices 1110. The MEMS display controller may have a monochromatic mode of operation running through controller 156 that sets up images in the frame buffer for display. The MEMS display controller can set shutters of the MEMS device into a configuration suitable for depicting the text information to be displayed to the user. Optionally, the operation mode may be in black and white or some other monochromatic color set that uses a lower power LED such as a white LED that is driven by a steady state voltage or by a light source that switches at a relatively slow rate sufficient for presenting graphic still images.

FIGS. 12A and 12B depict a further embodiment of the portable handheld devices described herein. In particular, FIG. 12A depicts a wristwatch 1200 that has a wrist strap 1202 that attaches the body of the wristwatch 1200 to the arm of the user. The wristwatch 1200 includes a housing 1204 that includes a display panel 1208. The display panel is a MEMS display panel that may be comparable to the MEMS display panels discussed above. The MEMS display panel fits within a watch housing that has a form factor suitable for being carried on the user's wrist.

In the embodiment depicted in FIG. 12A the MEMS display panel 1208 may include a segmented display section such as the segmented display sections discussed above. In particular, the display panel 1208 may comprise or include a display panel that has a display panel that has a segmented section such as the segmented section depicted in FIG. 12B. FIG. 12B illustrates one example of a segmented display that includes seven segments arranged into a figure eight. Each of the segments may include a plurality of shutter assemblies comparable to those discussed above that include transversely movable shutters capable of modulating light. Each of the segments has a group of shutter assemblies that are wired together and will therefore respond together to commands from the MEMS display controller contained within the watch 1200. The depicted segments may be formed on a class substrate that optionally is positioned above a light source. However, in the embodiment depicted in FIG. 12B, the light source may be a front light source, or optionally the display may be reflective for a reflective display, the transversally movable shutters may be reflective, or may slide over a reflective surface. Either way the transverse shutters will modulate light such that the respective segment in the seven segment display may be set in an on condition or an off condition as appropriate. As discussed above the segments may be monochromatic or may be colored and to that end the MEMS segment display controller may use field sequential color control or colored filters may be applied to the display as also discussed above.

In the embodiment depicted in FIG. 12B, the segmented display is shown as an independent display. However, in alternate embodiments of the invention, the segmented display of FIG. 12B may be one of a plurality of segmented displays laid out in a linear alignment so that a date, time, or other information can be displayed on the plural segmented displays. Additionally, the segmented displays may be formed on a substrate that also contains a matrix of transversally movable shutters thus providing a display that had integrated on it both a segmented display section and a pixilated display section. For example, in the watch application, the watch 1200 may have a upper section that is a pixilated display and allows for the presentation of an image such as a watch face, compass rose, or other image. Beneath the pixilated matrix may be the segmented display that can be used for presenting a readout of time, date, stop watch functions, as well as segmented display sections used for presenting icons such as whether an alarm is set, whether the time is am or pm, and a designation of the date such as WE to stand for Wednesday.

To this end, the MEMS display controller may include a segment display driver capable of driving a segmented display under the program control of the controller.

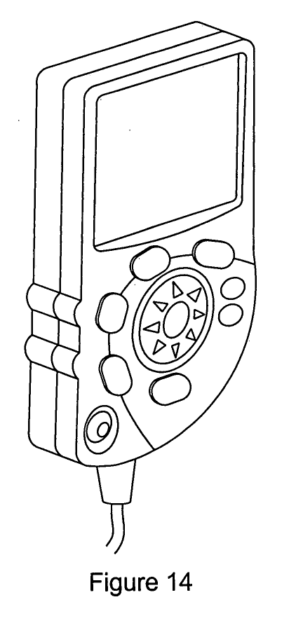

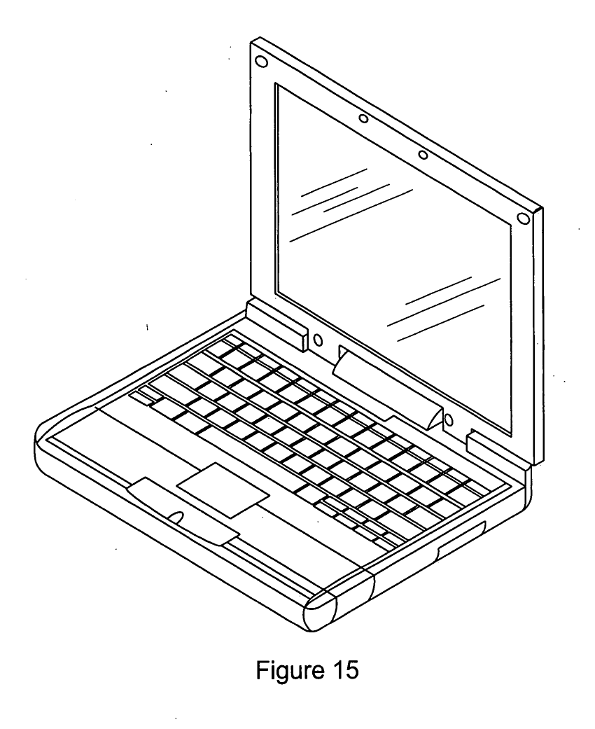

FIG. 13 depicts a media player having a display panel comparable to the MEMS display panels described above. FIG. 14 depicts a GNSS receiver having a display panel also similar to the display panels discussed above. FIG. 15 depicts a laptop computer having a display panel also comparable to the display panels discussed above. The laptop computer can employ the MEMS display controller to have power modes that conserve power in response to ambient light conditions measured by a light level detector, and in response to user controls and power source levels. For example, the systems and methods described herein can detect available power, or user input to conserve power, and move the mode of operation to a monochromatic mode, or chose a bit depth, such as 4 bit color, that provides a limited set of colors and conserves power.

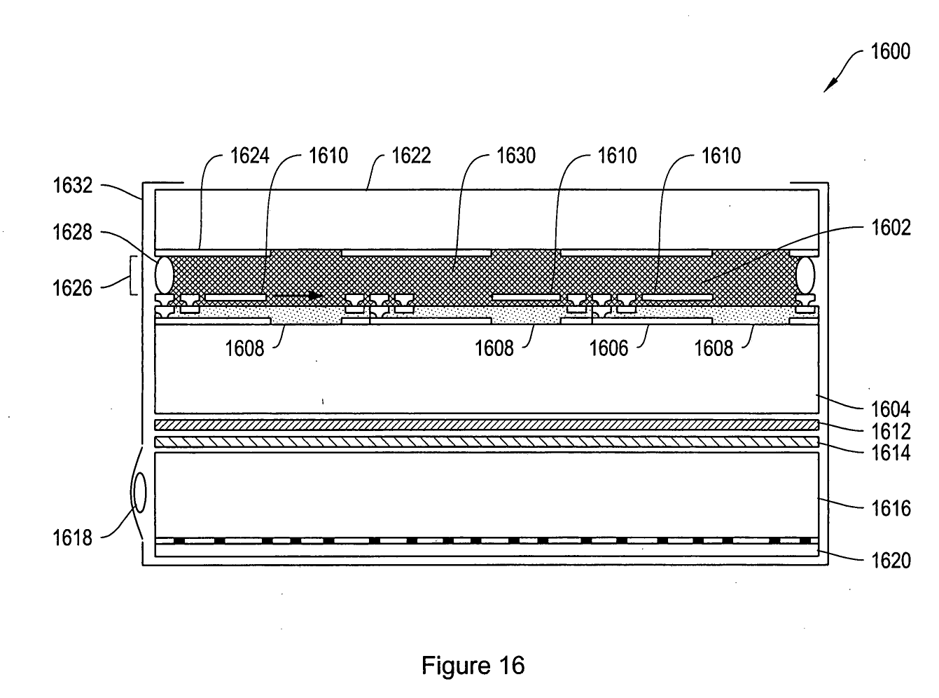

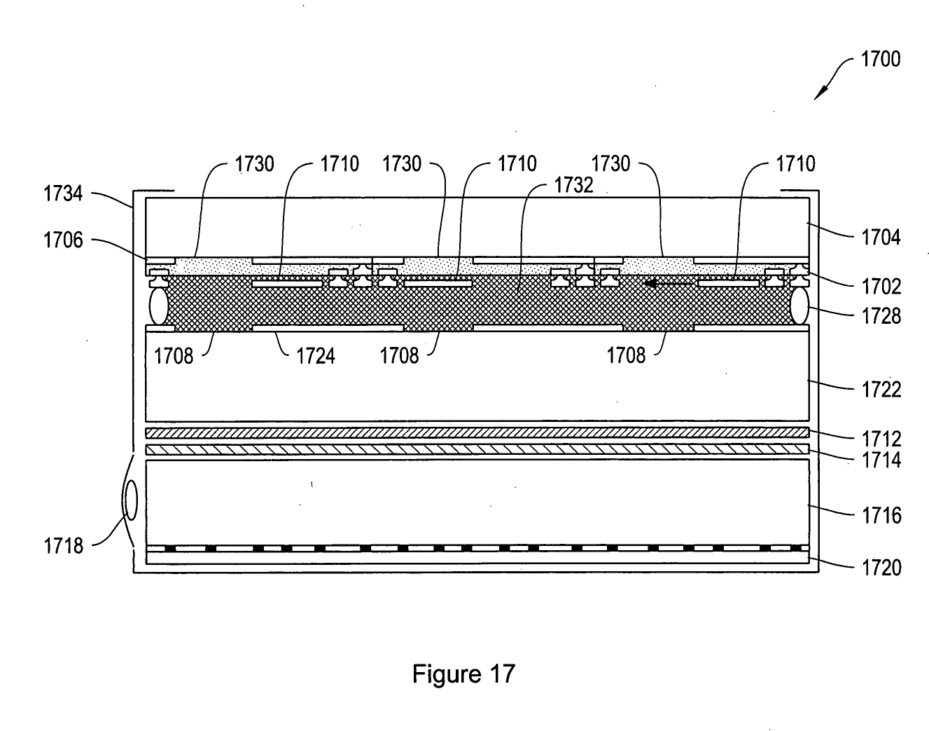

The MEMS display panel may have other forms. For example, FIGS. 16 and 17 depict alternate embodiments of MEMS display panels. FIG. 16 is a cross sectional view of a display assembly 1600 incorporating shutter assemblies 1602. The shutter assemblies 1602 are disposed on a glass substrate 1604. A reflective film 1606 disposed on the substrate 1604 defines a plurality of surface apertures 1608 located beneath the closed positions of the shutters 1610 of the shutter assemblies 1602. The reflective film 1606 reflects light not passing through the surface apertures 1608 back towards the rear of the display assembly 1600. An optional diffuser 1612 and an optional brightness enhancing film 1614 can separate the substrate 1604 from a backlight 1616. The backlight 1616 is illuminated by one or more light sources 1618. The light sources 1618 can be, for example, and without limitation, incandescent lamps, fluorescent lamps, lasers, or light emitting diodes. A reflective film 1620 is disposed behind the backlight 1616, reflecting light towards the shutter assemblies 1602. Light rays from the backlight that do not pass through one of the shutter assemblies 1602 will be returned to the backlight and reflected again from the film 1620. In this fashion light that fails to leave the display to form an image on the first pass can be recycled and made available for transmission through other open apertures in the array of shutter assemblies 1602. Such light recycling has been shown to increase the illumination efficiency of the display. A cover plate 1622 forms the front of the display assembly 1600. The rear side of the cover plate 1622 can be covered with a black matrix 1624 to increase contrast. The cover plate 1622 is supported a predetermined distance away from the shutter assemblies 1602 forming a gap 1626. The gap 1626 is maintained by mechanical supports and/or by an epoxy seal 1628 attaching the cover plate 1622 to the substrate 1604. The epoxy 1628 should have a curing temperature preferably below about 200 C, it should have a coefficient of thermal expansion preferably below about 50 ppm per degree C and should be moisture resistant. An exemplary epoxy 1628 is EPO-TEK B9016-1, sold by Epoxy Technology, Inc.

The epoxy seal 1628 seals in a working fluid 1630. The working fluid 1630 is engineered with viscosities preferably below about 10 centipoise and with relative dielectric constant preferably above about 2.0, and dielectric breakdown strengths above about 10⁴ V/cm. The working fluid 1630 can also serve as a lubricant. Its mechanical and electrical properties are also effective at reducing the voltage necessary for moving the shutter between open and closed positions. In one implementation, the working fluid 1630 preferably has a low refractive index, preferably less than about 1.5. In another implementation the working fluid 1630 has a refractive index that matches that of the substrate 1604. Suitable working fluids 1630 include, without limitation, de-ionized water, methanol, ethanol, silicone oils, fluorinated silicone oils, dimethylsiloxane, polydimethylsiloxane, hexamethyldisiloxane, and diethylbenzene.

A sheet metal or molded plastic assembly bracket 1632 holds the cover plate 1622, shutter assemblies 1602, the substrate 1604, the backlight 1616 and the other component parts together around the edges. The assembly bracket 1632 is fastened with screws or indent tabs to add rigidity to the combined display assembly 1600. In some implementations, the light source 1618 is molded in place by an epoxy potting compound.

FIG. 17 is a cross sectional view of a display assembly 1700 incorporating shutter assemblies 1702. The shutter assemblies 1702 are disposed on a glass substrate 1704. Display assembly 1700 includes a backlight 1766, which is illuminated by one or more light sources 1718. The light sources 1718 can be, for example, and without limitation, incandescent lamps, fluorescent lamps, lasers, or light emitting diodes. A reflective film 1720 is disposed behind the backlight 1716, reflecting light towards the shutter assemblies 1702. The substrate 1704 is oriented so that the shutter assemblies 1702 face the backlight.

Interposed between the backlight 1716 and the shutter assemblies 1702 are an optional diffuser 1712 and an optional brightness enhancing film 1714. Also interposed between the backlight 1716 and the shutter assemblies 1702 is an aperture plate 1722. Disposed on the aperture plate 1722, and facing the shutter assemblies, is a reflective film 1724. The reflective film 1724 defines a plurality of surface apertures 1708 located beneath the closed positions of the shutters 1710 of the shutter assemblies 1702. The aperture plate 1722 is supported a predetermined distance away from the shutter assemblies 1702 forming a gap 1726. The gap 1726 is maintained by mechanical supports and/or by an epoxy seal 1728 attaching the aperture plate 1722 to the substrate 1704.

The reflective film 1724 reflects light not passing through the surface apertures 1708 back towards the rear of the display assembly 1700. Light rays from the backlight that do not pass through one of the shutter assemblies 1702 will be returned to the backlight and reflected again from the film 1720. In this fashion light that fails to leave the display to form an image on the first pass can be recycled and made available for transmission through other open apertures in the array of shutter assemblies 1702. Such light recycling has been shown to increase the illumination efficiency of the display.

The substrate 1704 forms the front of the display assembly 1700. An absorbing film 1706, disposed on the substrate 1704, defines a plurality of surface apertures 1730 located between the shutter assemblies 1702 and the substrate 1704. The film 1706 is designed to absorb ambient light and therefore increase the contrast of the display.

The epoxy 1728 may have a curing temperature preferably below about 200 C, it should have a coefficient of thermal expansion preferably below about 50 ppm per degree C and should be moisture resistant. An exemplary epoxy 1728 is EPO-TEK B9022-1, sold by Epoxy Technology, Inc.

The epoxy seal 1728 seals in a working fluid 1732. The working fluid 1732 is engineered with viscosities preferably below about 10 centipoise and with relative dielectric constant preferably above about 2.0, and dielectric breakdown strengths above about 10⁴ V/cm. The working fluid 1732 can also serve as a lubricant. Its mechanical and electrical properties are also effective at reducing the voltage necessary for moving the shutter between open and closed positions. In one implementation, the working fluid 1732 preferably has a low refractive index, preferably less than about 1.5. In another implementation the working fluid 1732 has a refractive index that matches that of the substrate 1704. Suitable working fluids 1730 include, without limitation, de-ionized water, methanol, ethanol, silicone oils, fluorinated silicone oils, dimethylsiloxane, polydimethylsiloxane, hexamethyldisiloxane, and diethylbenzene.

A sheet metal or molded plastic assembly bracket 1734 holds the aperture plate 1722, shutter assemblies 1702, the substrate 1704, the backlight 1716 and the other component parts together around the edges. The assembly bracket 1732 is fastened with screws or indent tabs to add rigidity to the combined display assembly 1700. In some implementations, the light source 1718 is molded in place by an epoxy potting compound.

Further embodiments are also known. For example, although FIG. 4 and other figures graphically depict the MEMS display controller 70 and other elements of the devices described herein as functional block elements, it will be apparent to one of ordinary skill in the art that these elements can be realized as computer programs or portions of computer programs that are capable of running on the data processor platform, such as a DSP processor or a microprocessor, to thereby configure the data processor as a system according to the invention. As discussed above, the MEMS display controller, the color generator, the sync generator the power controller and other elements of the devices described herein can be realized as a software component operating on a data processing unit, such as a microprocessor. In that embodiment, these elements can be implemented as a C language computer program, or a computer program written in any high level language including C++, Fortran, Java or BASIC. Additionally, in an embodiment where microcontrollers or DSPs are employed, the elements can be realized as a computer program written in microcode or written in a high level language and compiled down to microcode that can be executed on the platform employed. The development of such control systems is known to those of skill in the art, and such techniques are set forth in Digital Signal Processing Applications with the TMS320 Family, Volumes I, II, and III, Texas Instruments (1990). Additionally, general techniques for high level programming are known, and set forth in, for example, Stephen G. Kochan, Programming in C, Hayden Publishing (1983). It is noted that DSPs are particularly suited for implementing signal processing functions, including preprocessing functions such as image enhancement through adjustments in contrast, edge definition and brightness. Thus, the forgoing embodiments are therefore to be considered in all respects illustrative, rather than limiting of the invention.

What is claimed is:

1. A portable handheld device, comprising
a housing,
a display panel seated within the housing and having a light modulating layer with a plurality of transversely moveable shutters capable of modulating light by transversely moving the respective shutter through a path of a propagating ray of light to set a respective pixel in an on condition or an off condition,
a control matrix coupled to the display panel for providing control over respective ones of the transversely moveable shutters for moving said transversely moveable shutters to modulate light, and
a power source disposed within the housing and coupled to the light source and the controller.

2. A portable handheld device according to claim 1, further comprising
a display controller coupled to the control matrix for controlling the moveable shutter elements to display an image.

3. A portable handheld device according to claim 2, wherein the display controller includes a color image generator capable of determining a sequence of on and off conditions for the moveable shutters and for driving respective moveable shutters through the determined sequence to display a color image.

4. A portable handheld device according to claim 1, further comprising
at least one color filter disposed within the display panel.

5. A portable handheld device according to claim 2 wherein the display controller includes
a sync controller coupled to the display panel and generating a sync pulse to move a group of moveable shutters to a selected state at predetermined intervals.

6. A portable handheld device according to claim 1, further comprising
an image memory having storage for an image signal and being coupled to the controller.

7. A portable handheld device according to claim 1, further comprising a removable memory storage device.

8. A portable handheld device according to claim 1, further comprising
a transparent substrate joined to a lower surface of the light modulating layer, and
a light source disposed beneath the transparent substrate.

9. A portable handheld device according to claim 8, wherein the light source comprises a plurality of light sources each capable of generating a selected color.

10. A portable handheld device according to claim 9, further comprising
a light controller for sequentially activating the plurality of light sources to display a color image.

11. A portable handheld device according to claim 1, further comprising
a light source disposed within the housing and arranged above the light modulating layer for directing light toward the moveable shutters.

12. A portable handheld device according to claim 1, further comprising
a user interface device coupled to the housing and capable of generating input signals responsive to user commands.

13. A portable handheld device according to claim 1, further comprising
a touch sensitive screen disposed over an upper surface of the display panel and capable of generating signals representative of a location on the display panel being pressed by a user.

14. A portable handheld device according to claim 1, wherein the display panel further comprises a fluid material surrounding the moveable shutters.

15. A portable handheld device according to claim 2, wherein the display controller a color bit controller for controlling the number of color bits employed for generating an image.

16. A portable handheld device according to claim 1, wherein the display panel further comprises
a transparent cover plate disposed over the light modulating substrate, and
a seal placed around a perimeter wall of the display panel and having a support surface to support a peripheral edge of the transparent cover plate.

17. A portable handheld device according to claim 16, wherein the transparent cover plate has a thickness selected to limit an inwardly directed deformation in response to an exterior pressure.

18. A portable handheld device according to claim 1, further comprising
a support disposed between the light modulating substrate and a cover plate and arranged to butt against and support the cover plate.

19. A portable handheld device according to claim 1, wherein the light modulating layer includes a plurality of apertures associated with respective ones of the moveable shutters, and further comprising
a reflective layer disposed beneath the light modulating layer and having a reflective surface facing the light modulating layer.

20. A portable handheld device according to claim 19, wherein the reflective layer includes a light transmissive medium disposed above the reflective surface, whereby a light reflective cavity is formed underneath the light modulating layer.

21. A portable handheld device according to claim 1, wherein
the control matrix includes an active matrix having a plurality of control circuits each being associated with a respective moveable shutter.

22. A portable handheld device according to claim 1, further comprising
a power controller coupled to the power source and having a plurality of operating modes for selectively regulating power drawn from the power source.

23. A portable handheld device according to claim 22, further comprising
wherein the power controller couples to a light source and includes a timer for changing the amplitude at which the light source is driven after a selected period of time.

24. A portable handheld device according to claim 22, wherein
the power controller couples to a light source to control at least one of amplitude or timing at which the source switches.

25. A portable hand held device according to claim 22, further comprising
a light source having a plurality of light sources for generating light of different colors, and
the power controller controls timing at which at least one of the light sources switches to generate colors that draw less power from the power source.

26. A portable handheld device according to claim 22, wherein
the power controller controls a light source to generate monochromatic light with a non-switched light source.

27. A portable handheld device according to claim 22, further comprising
a level detector coupled to the power controller for measuring a light external to the housing and for selectively regulating power drawn from the power source at least in part based on the measure.

28. A portable handheld device according to claim 1, include a device selected from the group of game consoles, cell phones, audio players, video players, watches, e-books, digital cameras, televisions, GNSS receivers, and laptop computers.

29. A portable handheld device according to claim 1, further comprising
a moveable contact formed on the light modulating layer and coupled to the control matrix and arranged for moving toward a respective moveable shutter to thereby reduce a voltage applied to move the shutter.

30. A portable handheld device, comprising
a housing,
a display panel seated within the housing and having transparent substrate with a light modulating layer formed on and bonded to the transparent substrate and having a plurality of moveable elements arranged for modulating light passing through the transparent layer,
a control circuit coupled to said moveable elements for controlling movement of said elements to modulate light,
a light source disposed within the housing beneath the transparent substrate to direct light through the transparent layer, and
a power source disposed within the housing and coupled to the light source and active matrix.

31. A portable handheld device, comprising
a housing,
an active matrix display panel seated within the housing and having a light modulating substrate formed on and bonded to the transparent substrate and having a plurality of moveable elements arranged for modulating light, and having a plurality of control circuits associated with respective ones of said moveable elements for controlling movement of the element to modulate light,
a light source disposed within the housing, and
a power source disposed within the housing and coupled to the light source and active matrix.
